(19) United States
(12) Patent Application Publication
(10) Pub. No.: US 2016/0050234 A1
(43) Pub. Date: Feb. 18, 2016

(54) SEAMLESS AUTHENTICATION ACROSS MULTIPLE ENTITIES

(71) Applicant: INTERDIGITAL PATENT HOLDINGS, INC., Wilmington, DE (US)

(72) Inventors: Vinod K. CHOYI, Norristown, PA (US); Alex Brusilovsky, Downingtown, PA (US)

(21) Appl. No.: 14/779,584

(22) PCT Filed: Mar. 27, 2014
(86) PCT No.: PCT/US14/31998

§ 371 Date: Sep. 24, 2015

Related U.S. Application Data
(60) Provisional application No. 61/805,851, filed on Mar. 27, 2013.

(51) Int. Cl. H04L 29/06

(52) U.S. Cl. CPC H04L 63/20; H04L 63/0281; H04L 63/105; H04L 63/12

(57) ABSTRACT

A user may be authenticated by an identity provider (IdP) and an authentication agent (AA), producing a result. Proof of the authentication, such as a ticket for example, may be provided to the SP. The UE may be authenticated with another IdP and another authentication agent, producing an associated result. Proof of the authentication, such as another ticket for example, may be provided to the SP. One or more of the authentication agents may reside on an authentication entity besides the UE. A multi-factor authentication proxy (MFAP) may trigger the authentication agents to nm authentication protocols and the MFAP may provide tickets to a client agent of the UE. A user may seamlessly transition between client agents on the same UE or between client agents on different UEs by leveraging authentications.

### CROSS REFERENCE TO RELATED APPLICATIONS

This Application claims the benefit of U.S. Provisional Patent Application Ser. No. 61/805,851 filed Mar. 27, 2013, the disclosure of which is hereby incorporated by reference as if set forth in its entirety herein.

### BACKGROUND

Many internet services (e.g., banking, multimedia, games, etc.) require authentication of a user of a device before the service can be accessed. For example, enterprises and “over-the-top” application service providers can assert a user's identity to have the user authorized. Service providers (SPs) often require users to create distinct registration profiles to access services that are provided by each service provider (SP). Thus, users often have numerous passwords and user names to access various services, creating a significant burden on the user.

Two-factor authentication may be used to strengthen the authentication of a user. An example two-factor authentication is based on a user's identity (ID) and password as a first authentication factor and a hardware/software-based token as a second authentication factor. A user ID and password authenticate the user's presence and the token confirms the user's possession of the device on which the token functionality resides. Multi-factor authentication refers to any authentication that uses more than one factor. Example authentication factors include user identities with corresponding passwords, tokens, and biometrics/behavioral aspects of a user.

### SUMMARY

Current approaches to multi-factor authentication do not leverage the capabilities of multiple devices. Various embodiments described herein leverage the capabilities of one or more devices, in addition to a user's user equipment (UE), to serve as authentication agents to achieve a desired level of multi-factor authentication.

Systems, methods and apparatus embodiments are described herein for authenticating a user and/or a user equipment (UE). As an example, a user equipment (UE) can include a multi-factor authentication proxy (MFAP) that operates to determine that multiple authentication factors are required to authenticate a user of the UE for access to a service provided by a service provider (SP). The MFAP can identify an authentication agent (AA) on a different device other than the UE to perform an authentication utilizing one of the required authentication factors. Further, the MFAP can establish a local link to the different device, which is a device that is different than the UE. The MFAP can trigger the authentication agent (AA) to perform the authentication. Thus, the MFAP can receive, via the local link, an assertion representative of a successful authentication by the AA. The MFAP may further operate to identify one or more additional authentication agents on the UE to perform authentication utilizing at least one other of the required authentication factors. Alternatively, the MFAP may operate to identify one or more additional authentication agents on a second different device from the UE to perform authentication utilizing at least one other of the required authentication factors.

In one example embodiment, a user that operates a UE requests access to a service controlled by a service provider (SP). The user may be authenticated by an identity provider (IdP) by means of an authentication agent (AA), producing a result. Proof of the authentication, such as a ticket for example, may be provided to the SP. The ticket may be a random value or it may be a cryptographically derived value that is tied to a session that performs the authentication. The UE may be authenticated with another IdP using another authentication agent, producing another result. Proof of the authentication, such as another ticket for example, may be provided to the SP. One or more of the authentication agents may reside on an entity besides the UE. A multi-factor authentication proxy (MFAP) may trigger the authentication agents to run authentication protocols and the MFAP may provide tickets to a first client agent, such as a browser or application of the UE for example. The MFAP may also provide for authentication of another client agent that is used by the same user and resides on a separate UE or on the same UE as the first client agent. For example, another client agent may be used to leverage an already occurred authentication that has a valid freshness level. Thus, seamless authentication with multiple entities may be enabled by the MFAP. For example, the multiple entities may be multiple client agents (e.g., browsers, applications) that reside on the same UE or multiple client agents that reside on different UEs. Thus, an entity may refer to an application that resides on a UE or the UE itself, for example.

In accordance with another example embodiment, an authentication system comprises a first user equipment (UE), a service provider (SP), and a multi-factor authentication proxy (MFAP). Based on a policy of the SP, the MFAP determines that a multi-factor authentication is required for a user of the first UE to access a service that is provided by the SP. The MFAP identifies a first authentication agent to perform a first factor authentication, and triggers the first factor authentication that results in a first ticket that may be sent to the MFAP. Similarly, the MFAP identifies a second authentication agent to perform a second factor authentication, and triggers the second factor authentication that results in a second ticket that may be sent to the MFAP. The second authentication agent may reside on a different device than the first authentication agent. The MFAP sends the first and second tickets to a first client agent, such as a browser for example, of the first UE, thereby enabling the first UE to access the service that is provided by the SP. In accordance with one embodiment, the MFAP resides on the first UE. Alternatively, the MFAP may reside on a second UE, and the MFAP may communicate with the first client agent of the first UE via a local link (e.g., Bluetooth) or a remote link. At least one of the authentication agents may reside on the first UE. Alternatively, at least one of the first and second authentication agents may reside on a second UE that is different than the first UE. In accordance with yet another embodiment, if a user uses the first client agent and wants to switch to using a second client agent, then the MFAP facilitates the authentication so that the user using second client agent may be seamlessly authenticated (e.g., leveraging the authentication carried out using first client agent) using a single factor or multiple factors by means of an IdP or in a proxy manner by means of the MFAP. The first client agent and the second client agent may reside on the same UE or they may reside on different UEs.

In an example embodiment, the policy of the SP comprises a required assurance level of the multi-factor authentication, and the first and second authentication agents may be used to obtain the required assurance level of the multi-factor authentication. The assurance level of the authentications may be combined to form an aggregated authentication assurance level. It will be understood that any number of authentication agents may be utilized as desired, such than any number of factors of authentication may be completed as desired. Each authentication agent may be associated with a corresponding identity provider. For example, the first authentication agent may generate the first ticket and its associated IdP may generate a ticket that is compared to the first ticket. If the tickets match, the factor of authentication that corresponds to the first authentication agent is successful. In an alternate example embodiment, the IdP may generate a ticket that is sent by the IdP to the associated authentication agent, and the ticket is presented by the authentication agent to the client agent to obtain access to the service. If the ticket that is presented by the client agent in order to obtain a service matches the ticket that the IdP provided to the master IdP, then the authentication is successful.

### BRIEF DESCRIPTION OF THE DRAWINGS

A more detailed understanding may be had from the following description, given by way of example in conjunction with the accompanying drawings wherein:

FIG. 1 is a block system diagram of an example authentication system with multiple authentication entities according to an example embodiment;

FIG. 2 is a table that illustrates an example of a mapping of authentication factors to authentication assurance levels;

FIG. 3 is a flow diagram for multi-factor authentication using multiple authentication entities according to an embodiment;

FIG. 4A is a flow diagram for three-factor authentication using an OpenID (OID)-Generic Bootstrapping Architecture (GBA) (OID-GBA) according to an example embodiment;

FIG. 4B is a flow diagram for two-factor authentication that is based on the OID-GBA according to an example embodiment;

FIG. 4C is another flow diagram for two-factor authentication that is based on OID-GBA according to another example embodiment, wherein a browser is separate from a UE;

FIG. 4D is a flow diagram for three-factor authentication in which a ticket that is generated during a user authentication is looped through a GBA process in accordance with an example embodiment;

FIG. 4E is a flow diagram of the three-factor authentication shown in FIG. 4D, with additional detail depicted;

FIG. 4F is a compressed version of the call flow that is depicted in FIG. 4E;

FIG. 5A is a flow diagram for multi-factor authentication in which a fresh authentication result is asserted in accordance with an example embodiment;

FIG. 5B is a flow diagram for multi-factor authentication in which multiple fresh authentication results are asserted in accordance with an example embodiment;

FIG. 6A is a system diagram of an example communications system in which one or more disclosed embodiments may be implemented;

FIG. 6B is a system diagram of an example wireless transmit/receive unit (WTRU) that may be used within the communications system illustrated in FIG. 6A; and

FIG. 6C is a system diagram of an example radio access network and an example core network that may be used within the communications system illustrated in FIG. 6A.

### DETAILED DESCRIPTION OF ILLUSTRATIVE EMBODIMENTS

The ensuing detailed description is provided to illustrate example embodiments and is not intended to limit the scope, applicability, or configuration of the invention. Various changes may be made in the function and arrangement of elements and steps without departing from the spirit and scope of the invention.

As described above, current approaches to multi-factor authentication do not leverage the capabilities of multiple devices. In particular, current approaches do not use multiple devices to achieve strong multi-factor authentication while seamlessly switching between each of the multiple devices. Various embodiments described herein leverage the capabilities of one or more devices, in addition to a user's user equipment (UE), to serve as authentication agents to achieve a desired level of multi-factor authentication. In one example embodiment, multiple authentication entities, such as multiple devices for example, are used to provide strong multi-factor authentication. Further, the multiple devices may communicate seamlessly with each other to provide multiple authentication factors. As described below, multi-factor authentication may be implemented in split-terminal scenarios in accordance with various embodiments. A split-terminal scenario, which can also be referred to as a split-scenario, may refer to any scenario in which a UE is divided into more than one part for authentication of the UE. In one split-terminal scenario, presented by way of example, a given UE is authenticated using a UICC of the given UE and a browser that is located separately, for example on a different device, from the given UE. Split-terminal scenarios may also refer to scenarios in which a multi-factor authentication proxy (MFAP) uses the services of other local authentication device that are paired with the MFAP using a local link, such as a usb connection, WiFi, infrared, Bluetooth/NFC, or the like. Example local authentication devices include, without limitation, a smart watch, Google glasses, or other wearable computing devices, standalone biometric or behavioral sensors, or the like. In an example embodiment, multi-factor authentication is based on a OpenID (OID) Generic Bootstrapping Architecture (GBA) (OID-GBA). Multi-factor authentication results may be combined and delivered to a service provider (SP), for example, so that a user/user equipment (UE) can receive access to a service that is provided by the SP. In an example embodiment, an authentication binding is created using the results of multiple authentication factors. As described below, multi-factor authentication may be performed using a GBA framework, such as an OpenID/GBA framework for example.

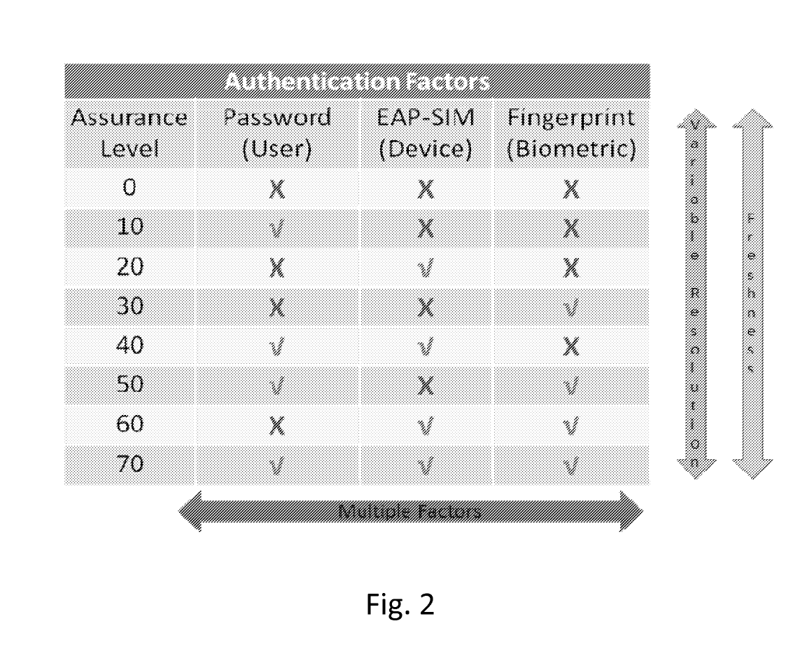

In order to access a service, a user may have to meet authentication requirements of a SP that provides the service. Authentication requirements may be based on authentication policies of the various services. For example, a policy of a SP may require that an authentication meets a predetermined assurance level, which may also be referred to as an authentication strength, before a service that is provided by the SP is accessed. Thus, referring to FIG. 2, assurance levels may indicate a strength of an authentication, and a high assurance level may require multiple factors of authentication. In an example embodiment, the assurance level refers to a level of assurance in which a user is authenticated. The assurance level may be based on authentication protocols being used, a number of factors for authentication, a type of authentication factor (e.g., biometric, device, user) a freshness of the authentication, supplementary conditions, or any appropriate combination thereof. The assurance level may be defined by an external authority. In an example embodiment, desired assurance levels are specified by various external authorities, such as standard bodies including, for example, National Institute of Standards and Technology (NIST), 3^{rd} Generation Partnership Project (3GPP), World Wide Web Consortium (W3C), or the like. For example, an external authority may specify assurance levels based on various criteria such as, for example, security requirements of an application itself, security policies of a company that hosts the requested service, or the like. By way of further example, an SP may specify an assurance level that it requires in order for the SP to provide a requested service to a user.

Still referring to FIG. 2, an SP may require that an authentication freshness level is met before allowing access to a service. An authentication freshness level that corresponds to an authentication may indicate the time period in which the authentication was performed. As an example of a freshness level, presented without limitation, an SP may require that an authentication be carried out within the last 30 seconds. In some cases, multi-factor authentication may have to be accommodated in order to comply with authentication policies of a SP. Based on the various policies of SPs, for example, multiple authentication agents may be used to authenticate a user or a UE in accordance with various embodiments described herein.

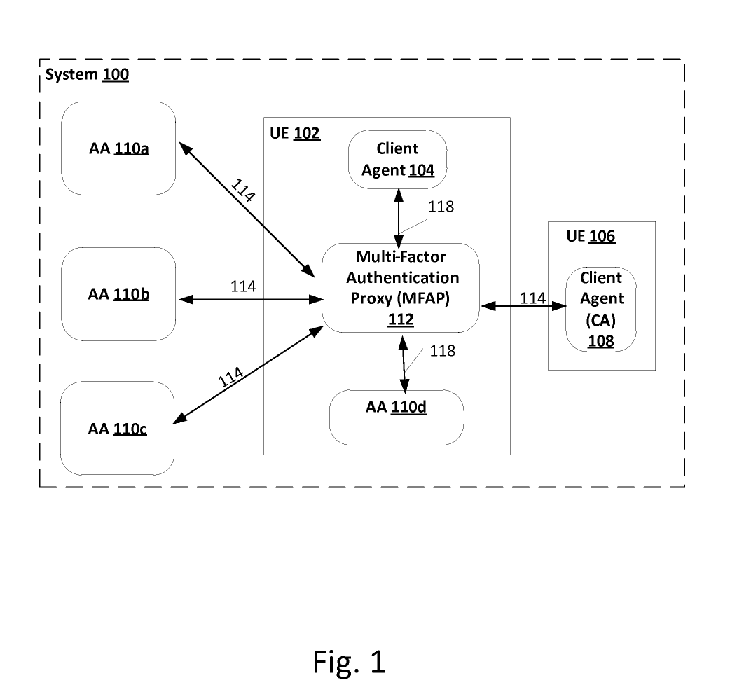

FIG. 1 shows an example authentication system 100 in accordance with an example embodiment. Referring to FIG. 1, in accordance with the illustrated embodiment, the authentication system 100 includes a first user equipment 102 that includes a first client agent 104. The term client agent generally refers to a browser or a client application that resides on a UE. In accordance with the illustrated embodiment, the first client agent (CA) 104 refers to a browser or a client application that resides on the first UE 102. It will be understood that the term user equipment (UE) may refer to a device that includes any appropriate wireless transmit/receive unit (WTRU), as further described below. For example, a WTRU may refer to a fixed or mobile subscriber unit, a pager, a cellular telephone, a personal digital assistant (PDA), a smartphone, a laptop, a tablet computer, a personal computer, a wireless sensor, consumer electronics, or the like. As used herein, unless otherwise specified, a UE that initiates a service may be referred to as a primary UE, and a UE that continues a session after it is initiated by the primary UE may be referred to as a secondary UE. For example, referring to FIG. 1, the UE 102 may initiate access to a service, and another UE, such as a second UE 106 for example, continues to access the service after the UE 102 initiated the access to the service. Thus, the first UE 102 may be referred to as the primary UE and the second UE 106 may be referred to as the secondary UE. Although FIG. 1 depicts two UEs, it will be understood that any number of UEs may be used to access a service as desired in accordance with various embodiments described herein.

A CA may reside on at least one, for instance both, of the primary UE and the secondary UE. Referring to FIG. 1, the first CA 104 resides on the first UE 102 and a second CA 108 resides on the second UE 106. A user may have multiple UEs such as a Smart Phone, Tablet, Laptop, or Desktop for example, and a CA may reside on at least one of the UEs. Thus, in accordance with illustrated embodiment, a user may start an application or service on the first UE 102 (the primary UE), which can be a smart phone for example, and then the user may continue to use the same application or service seamlessly on the second UE 106, which can be a tablet for example, using the second CA 108 that resides on the second UE 106. For example, the user of the first UE 102 can transition to the second CA 108 by leveraging an authentication of the first CA 104. While the second CA 108 is illustrated as residing on the second UE 106, it will be understood that the second CA 108 may alternatively reside on the first UE 102.

With continuing reference to FIG. 1, the authentication system 100 may include one or more authentication agents (AAs) 110, such as, for example, a first authentication agent (AA) 110a, a second AA 110b, a third AA 110c, and a fourth AA 110d. While four authentication agents are illustrated, it will be understood that any number of authentication agents can be included in an authentication system as desired. The authentication agents 110 may include hardware and/or software that provides the first UE 102, which can also be referred to generally as a client, functionality for an authentication. In some cases, authentication agents are implemented on a UE, such as, for example, the fourth AA 110d that is implemented by the first UE 102. Thus, at least one of the authentication agents can be at least a portion of the UE 102. Further, at least one of the authentication agents can reside on the second UE 106. Alternatively, authentication agents may be implemented as standalone authentication devices or client functions. In accordance with the illustrated example embodiment, the first AA 110a is implemented by an identity module, such as a subscriber identity module (SIM), a software SIM, or a universal integrated circuit card (UICC) for example, that resides on a mobile device (e.g., a phone). The second AA 110b may be implemented by an electronic key fob. The third AA 110c may be implemented by a stand-alone biometric client. Example stand-alone biometric clients include a fingerprint reader, a smart watch that measures a pulse or otherwise verifies that a person is alive, head-phones that recognize ear-lobes, glasses that can be used for iris scanning or other facial recognition/eye verification, other wearable devices that include biometric sensors, or the like. It will be understood that the illustrated authentication agents are presented for purposes of example, and various alternative authentication agents may be used in various embodiments herein. For example, an AA may consist of an application that stores credentials of a user or a UE. As described further below, in accordance with the illustrated embodiment, the authentication agents 110 may participate in the authentication of the first UE 102 and/or the user of the first UE 102. The first CA 104 and the authentication agents AA 110 may communicate with each other via various means such as, for example, an internal communication, a local link (e.g., Bluetooth), or a remote. A local link may refer to communication over WiFi, infrared, or the like. The MFAP 112 may communicate with a given AA using a local link. A remote link may refer to a communication link between two devices, wherein the link is via the MFAP 112. As used herein, an internal communication refers to a communication that takes place within a single device.

Still referring to FIG. 1, in accordance with the illustrated embodiment, a multi-factor authentication proxy (MFAP) 112 resides on the first UE 102. The MFAP 112 may be located on a user device, such as the first UE 102 for example. The MFAP 112 may provide mechanisms which enable multi-factor authentication and assertion in split terminal or multi-device scenarios. In accordance with an example embodiment, the MFAP 112 is configured to determine an assurance level that is requested. The MFAP 112 may be further configured to translate the assurance level requests to factors of authentication. For example, each of the translated factors of authentication may have a respective authentication strength associated with it. Thus, the MFAP may translate an assurance level request to a combination of authentication factors that achieve the requested assurance level. The MFAP 112 may be further configured to contact a proxy engine to translate policies of service providers to determine authentication factors for a multi-factor authentication.

In an example embodiment, after the authentication factors are determined, the MFAP 112 communicates with one or more authentication agents (AAs) to trigger each of the authentication factors. Communication between an MFAP and an AA may be performed within the same entity, over a local link, or over a remote link. Referring to FIG. 1, in accordance with the illustrated embodiment, the MFAP 112 communicates with the second AA 110b over a local link 114. The MFAP 112 also communicates with the first and third authentication agents 110a and 110c, respectively, over the local link. Further, the illustrated MFAP 112 communicates with the fourth AA 110d over an internal link 118.

As further described below, the MFAP 112 may be further configured to combine multiple authentication factors and compute an aggregate assurance level that is associated with the combination of the multiple authentication factors. Further, a given MFAP and a given AA may authenticate each other so that only authorized MFAPs and AAs are able to communicate with one another and so that the communications between the MFAP and the AAs are secure. Further, a given MFAP and a given CA may authenticate each other so that only authorized MFAPs and CAs are able to communicate with one another and so that the communications between the MFAP and the CA are secure.

Referring again to FIG. 1, in accordance with the illustrated embodiment, the MFAP 112 communicates the results of the authentications to the first CA 104 over the internal link 118. For example, the MFAP 112 may communicate the freshness levels and the assurance levels that are associated with each authentication factor. Further, the MFAP may communicate the aggregate assurance level, which represents the combined assurance level of each authentication factor that was performed, to the CA 104. The MFAP 112 may communicate with a CA over means as desired, such as the local link 114 or the internal link 118. In accordance with the illustrated embodiment, the MFAP 112 communicates with the first CA 104 over the internal link 118 within the first UE 102, and the MFAP 112 communicates with the second CA 104 over the local link 114.

Thus, the MFAP 112 may determine that multiple authentication factors are required to authenticate a user of the UE 102 for access to a service provided by a service provider (SP). The MFAP 112 may identify an authentication agent (AA) on a different device than the UE 102, for instance the UE 106, to perform an authentication utilizing one of the required authentication factors. The MFAP 112 may establish a local link to the different device (e.g., UE 106), and the MFAP 112 may trigger the AA to identified AA to perform the authentication. In response, the MFAP 112 may receive, via the local link, an assertion representative of a successful authentication by the AA.

In an example embodiment, the MFAP 112 assumes a client-type role to an identity provider (IdP) server that is located on a network. The IdP may be designated as a master IdP by determination of a user's preferred identifier. In an example embodiment, the master IdP, through an interworking agreement with a SP, has responsibility for authenticating the user and/or the device. For example, the master IdP may comprise assets to perform the authentication itself, whether the authentication is one-factor or multi-factor. Alternatively, the master IdP may employ the assets of other IdPs in addition to or in lieu of its assets. For example, the master IdP may trigger other IdPs to create contexts so that the IdPs can assert identities based on the results produced by authentication agents. Further, the master IdP may act as a server to the MFAP 112.

The MFAP 112 is configured with information to enable it to invoke the services of an authentication agent. For example, the configured information may include URLs that correspond to respective authentication agents, IP addresses of authentication agents, MAC addresses of authentication agents, parameters required by a given AA in order to initiate authentication from the given AA, or the like. In accordance with the illustrated embodiment shown in FIG. 1, the MFAP 112 resides on the same device (UE 102) that hosts the browsing agent (CA 104) and an AA (the fourth AA 110d). Alternatively, the MFAP 112 may reside on an entity that does not host a browsing agent, but does host an AA. In yet another embodiment, the MFAP 112 may reside on a device that does not perform either a browsing or an authentication function. Functionality of the MFAP 112 may be implemented as a plug-in to a browser or incorporated into an application. An application programming interface (API) for invoking the function of the MFAP may be provided such that multiple client agents (e.g., browsers, applications) can invoke it. For example, the MFAP 112 may exist as a stand-alone application that is invoked with API calls from other applications. The MFAP 112 may exist as a stand-alone application that is triggered by browser interactions, for example, using intents.

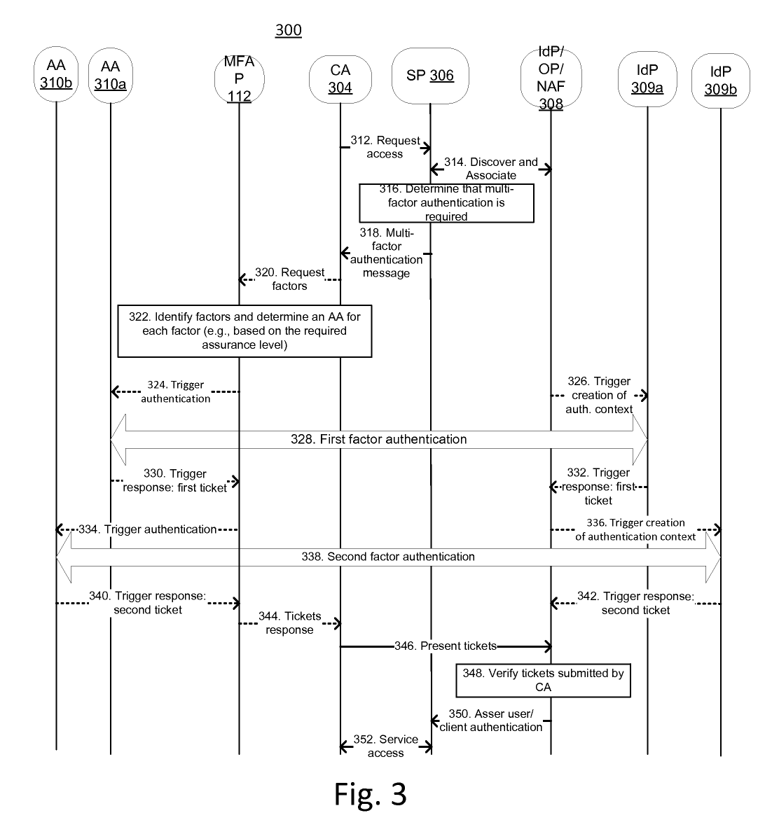

Referring now to FIG. 3, an example authentication system 300 includes one or more authentication agents, for instance a first AA 310a and a second AA 310b, a CA 304, a SP 306, a master IdP 308, and the MFAP 112. Reference numbers are repeated throughout the figures for convenience, and it will be understood that reference numbers that appear in more than one figure refer to the same or similar features in each figure in which they appear. While two authentication agents are illustrated in the authentication system 300, it will be understood that the number of authentication agents in the authentication system 300 may vary as desired. In accordance with the illustrated embodiment, the first authentication agent 310a and the second authentication agent 310b are associated with a first IdP 309a and a second IdP 309b, respectively. Further, the authentication agents 310a and 310b and the identity providers 309a and 309b enable a two-factor authentication so that the CA 304 can be provided with access to services offered by the SP 306. The SP 306, the master IdP 308, the first IdP 309a, and the second IdP 309b, may collectively be referred to as the network-side of the authentication system 300. The SP 306 may also be referred to as a relying party (RP) 306, without limitation. Although an example two-factor authentication is illustrated in FIG. 3, it will be understood that the call flow shown in FIG. 3 may be extended for an authentication that uses more than two-factors. In accordance with the illustrated embodiment, the MFAP 112 assesses the policy requirements of the SP 306 and the master IdP 308 translates the policies to determine parameters of authentication protocols that will meet the policy requirements.

With continuing reference to FIG. 3, the CA 304 may invoke services of the MFAP 112 based on requirements provided by the SP 306. For example, the MFAP 112 may translate policies to determine the required authentication factors, the required authentication strengths (assurance levels), and/or the required freshness levels of authentication. The MFAP 112 may trigger the start of various authentication protocols by contacting each of the required authentication agents after the required authentication agents are determined. In accordance with the illustrated embodiment, the MFAP 112 combines the results of the authentication protocols that were triggered, and presents the results of the authentication to the CA 304. The master IdP 308 may collect the results of each of the authentication factors with their respective assurance levels from each of the IdPs 309a and 309b. The master IdP 308 may assert an identity of the CA 304 and/or a user of the CA 304 to the SP 306. The assertion may be based on proof (e.g., tickets) of multi-factor authentications that master IdP 308 receives from the CA 304. In various example embodiments, the master IdP 308 may compare tickets it receives from the CA 304 to tickets it receives from each of the IdPs 309a and 309b. As used herein, the term ticket may refer generally to an authentication parameter. For example, a ticket may represent a nonce, a cryptographic value, or an authentication assertion.

Still referring to FIG. 3, in accordance with the illustrated embodiment, at 312, a user requests access to a service (provided by the SP 306) via the CA 304. The CA 304 may communicate with the SP 306, and the communication may include a user ID that is associated with the user. Based on the user ID, at 314, the SP 306 performs a discovery and associates with the master IdP 308 that is associated with the user ID. The master IdP 308 may perform functionality that is associated with an OpenID Identity Provider (OP) or a network access function (NAF), and thus the master IdP 308 may also be referred to as an OP 308 or a NAF 308. At 316, in accordance with the illustrated embodiment, the SP 306, for example based on a policy of the SP 306, determines that a multi-factor authentication is required in order for the user to access the requested service that is provided by the SP 306. The SP 306 may also determine the level of assurance of the authentication that is required in order for the user to access the requested service that is provided by the SP 306. At 318, in accordance with the illustrated embodiment, the SP 306 communicates its assurance level requirement to the CA 304. At 320, the CA 304 invokes services of the MFAP 112.

In an example embodiment, the CA 304 and the MFAP 112 authenticate each other such that the services of the MFAP 112 are securely invoked. The mutual authentication may ensure that only an authenticated CA invokes the services of the MFAP 112 and that only an authenticated MFAP serves the CA 304. Referring still to FIG. 3, at 320, the CA 304 may invoke the services of the MFAP 112 by using an API call via a local link or an internal link as described with reference to FIG. 1. It will be understood that the API call may be sent over any communication link as desired. In accordance with the illustrated embodiment, the CA 304 also provides the assurance information that is required by the SP 306. At 322, based on the level of assurance that is required to access the service, for example, the MFAP 112 determines the types and strengths of the authentication factors that can be performed to achieve the required assurance level. The MFAP 112 may further identify authentication agents that can perform the required authentications. For example, in accordance with the illustrated embodiment, the MFAP 112 determines that the first AA 310a and the second AA 310 are associated with the determined types and strengths of authentication factors. After the first authentication agent 310a is identified, at 324, the MFAP 112 sends a trigger to the first authentication agent 310a so that that the first authentication agent 310a initiates an authentication protocol. At 326, the master IdP 308 triggers a process in which a context is created for the authentication protocol that is initiated by the first authentication agent 310a. For example, the master IdP 308 may communicate with the first IdP 309a that is associated with the first AA 310a to request that the first IdP 309a create a context for the first AA-initiated authentication. The steps performed at 324 and 326 may be performed in parallel with each other.

With continuing reference to FIG. 3, in accordance with the illustrated embodiment, at 328, the first AA 310a and the first IdP 309a carry out an authentication. The authentication may comprise an authentication of the user of the CA 304 (e.g., a biometric of the user), of the CA 304, of a device that is associated with the CA 304, or the like. A ticket, such as a first ticket for example, may be generated by the first IdP 309a upon a successful authentication. The first ticket is sent to the first authentication agent 310a in accordance with the illustrated embodiment. The ticket that is generated by the first IdP 309a may be sent to the first AA 310a in a secure manner. Alternatively, the first ticket may be generated by the first AA 310a using similar mechanisms used by the first IdP 310b to generate the first ticket. Regardless, at the end of the authentication, both the first AA 310a and the first IdP 309a may have proof of the authentication, and the proof is referred to as the first ticket in accordance with FIG. 3.

At 330, in response to the trigger that was received at 324, the first AA 310a may send a trigger response that comprises the first ticket. The trigger response may be sent to the MFAP 112, and the trigger response may prove that a successful authentication was performed. At 332, at the network-side, the first IdP 309a may send the first ticket and its associated freshness (e.g., date/time of when the authentication was carried out) to the master IdP 308.

At 334, based on policies for example, the MFAP 112 may initiate the start of a second authentication using a second authentication factor by sending a trigger to the second AA 310b. At 336, in accordance with the illustrated embodiment, the master IdP 308 sends a trigger to the second IdP 309b to create a second authentication context. The second authentication context that is triggered is associated with the second authentication, using the second authentication factor, that is performed by the second AA 310b. The steps at 334 and 336 may be performed in parallel with each other. At 338, in accordance with the illustrated embodiment, a second factor authentication is carried out between the second AA 310b and the second IdP 309b. The second factor that is used to perform the second factor authentication may be a biometric of a user, another factor associated with the user, a factor associated with the device, a factor associated with a behavioral analysis of the user, or the like. Alternatively, for example, the second factor authentication may be carried between the second AA 310b and the user. Such an authentication may include, for example, a biometric authentication, an authentication of a factor associated with the user device, or a factor associated with a behavioral analysis of the user. At the end of the second factor authentication, the second IdP 309b may generate a ticket, such as a second ticket for example. The second ticket may comprise a random nonce and/or the ticket may be cryptographically generated. The second ticket may be sent to the second AA 310b. Alternatively, in an example embodiment, the second AA 310b generates the second ticket using similar mechanisms used by the second IdP 309b to generate the second ticket, and thus the second ticket is not sent to the second AA 310b from the second IdP 309b. At 340, in response to the trigger that was sent at 334, the second AA 310b sends the second ticket and its associated freshness to the MFAP 112. Similarly, at 342, the second IdP 309b may send the second ticket and the freshness of the authentication associated with the ticket to the master IdP 308. Alternatively, for example if a local authentication is carried out by second AA 310b, the second AA 310 may generate the second ticket and forward the second ticket to the MFAP 112.

With continuing reference to FIG. 3, in accordance with the illustrated embodiment, at 344, the MFAP 112 consolidates the first ticket and the second ticket. The MFAP may further compute an aggregate achieved assurance level and freshness level for the CA 304. In one example, an aggregate assurance level is computed by summing the assurance level associated with each authentication factor together. By way of another example, assurance levels may be weighted such that one authentication factor is weighed more heavily as compared to another authentication factor in the aggregate assurance level that corresponds to both authentication factors. Additional parameters, such as a freshness decay function, which factors in the age of each authentication factor, may be considered in computing the aggregate assurance factor. In another embodiment, MFAP 112 does not send the computed aggregate assurance level, but instead sends the information relating to each of the factors of authentication to the master IdP, and the master IdP may compute the aggregate assurance level. At 346, the CA 304 presents the first and second tickets to the master IdP 308. The CA 304 may further transmit achieved assurance level and the freshness associated with each of the authentications to the master IdP 308. At 348, the master IdP 308 compares the first and second tickets that it received from the CA 304 to the first and second tickets that were delivered to it by the first and second IdPs 310a and 310b, respectively. At 350, if both of the first tickets match each other and both of the second tickets match each other, for example, the master IdP 308 creates an assertion. The master IdP 308 sends the assertion to the SP 306. The assertion that is sent may include the assurance level and the freshness level that was achieved by the multi-factor authentication that was performed. Alternatively, if local authentications were carried out for example, the MFAP 112 may present the tickets and assertion directly to the SP 306. At 352, in accordance with the illustrated embodiment, the SP 306 verifies the assertion and provides a success message to the CA 304, thereby by providing the CA 304 and the user of the CA 304 with access to the requested service provided by the SP 306.

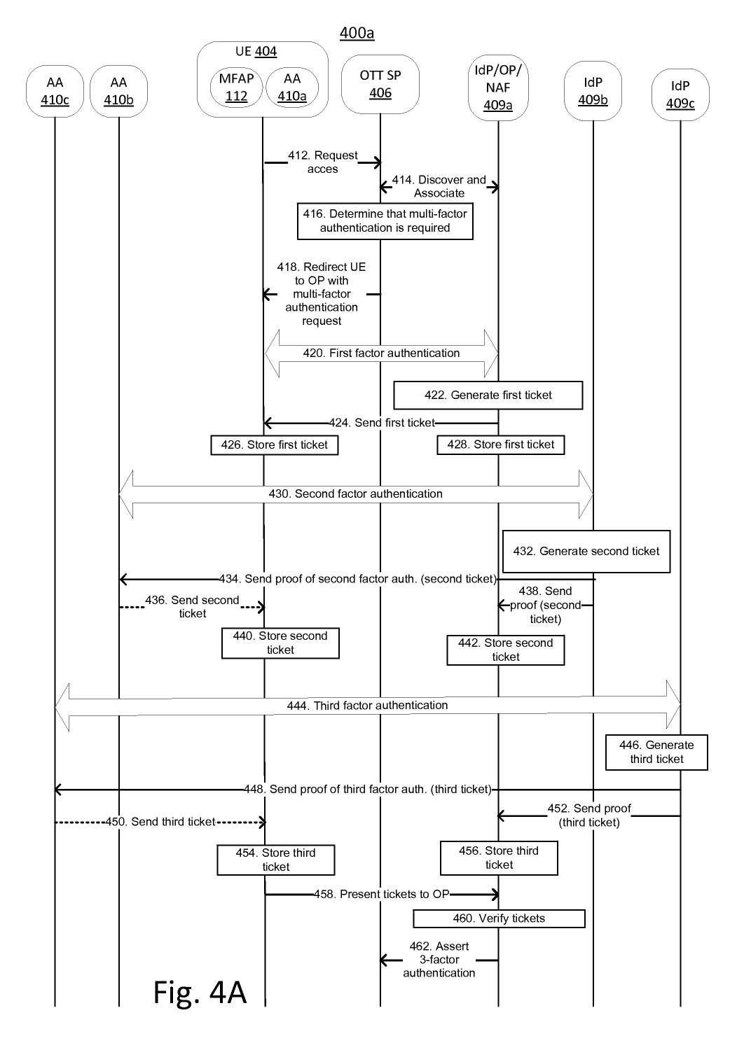

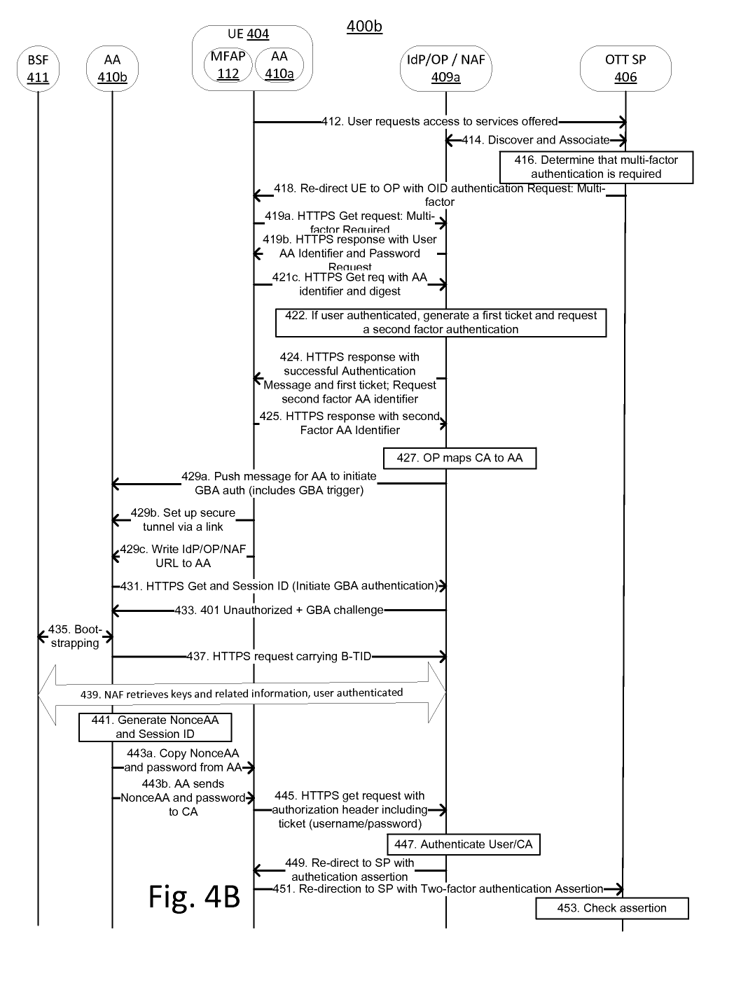

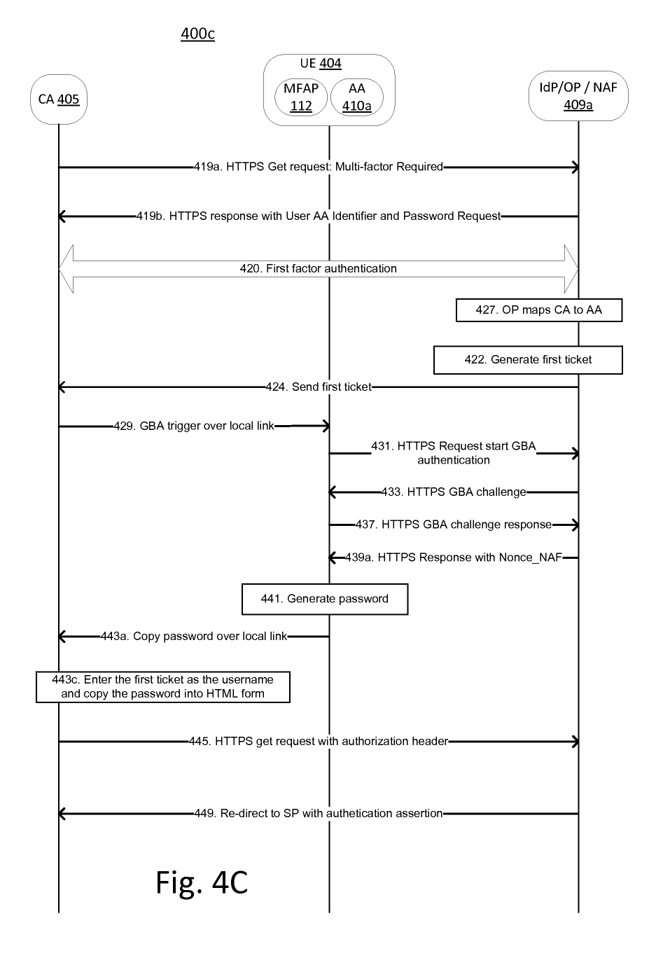

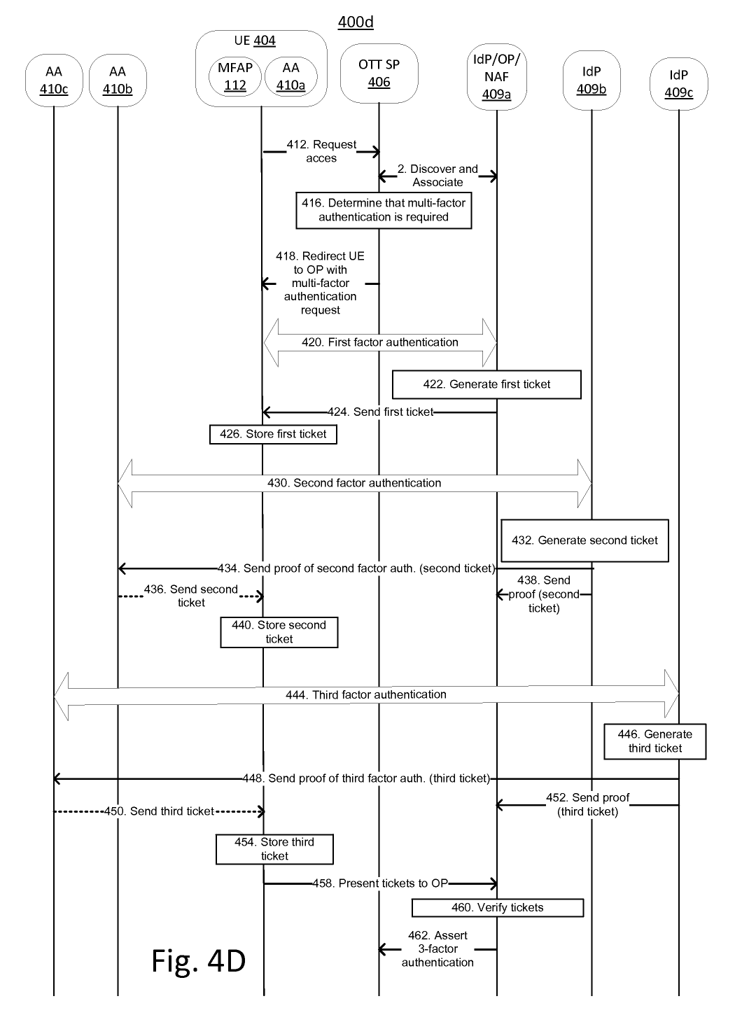

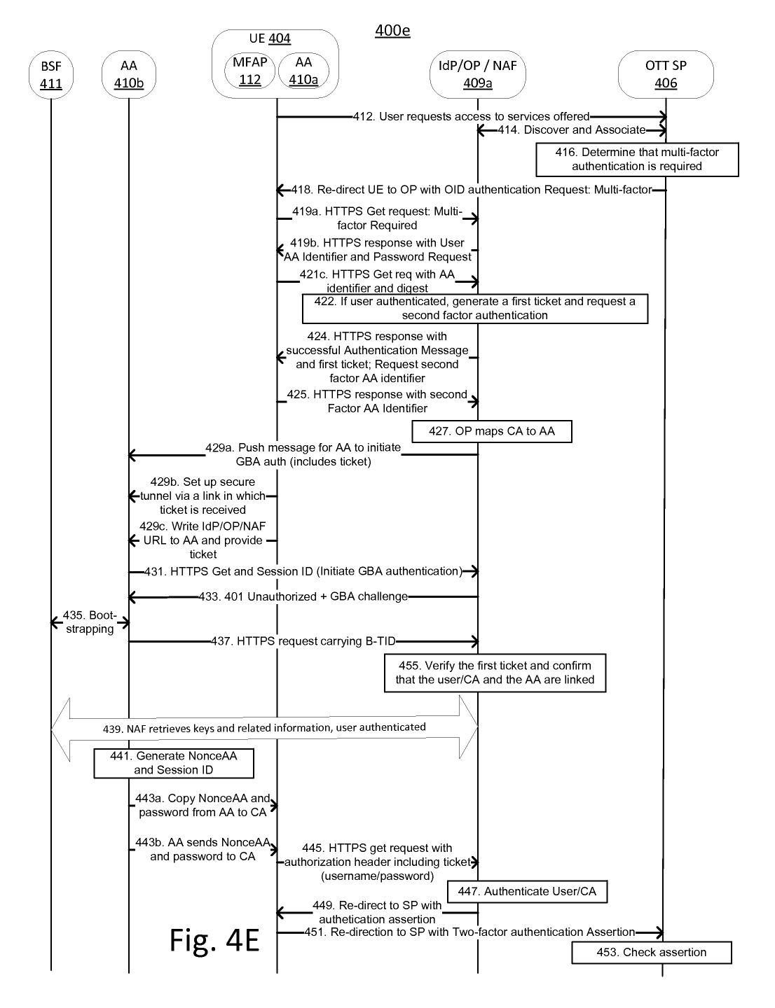

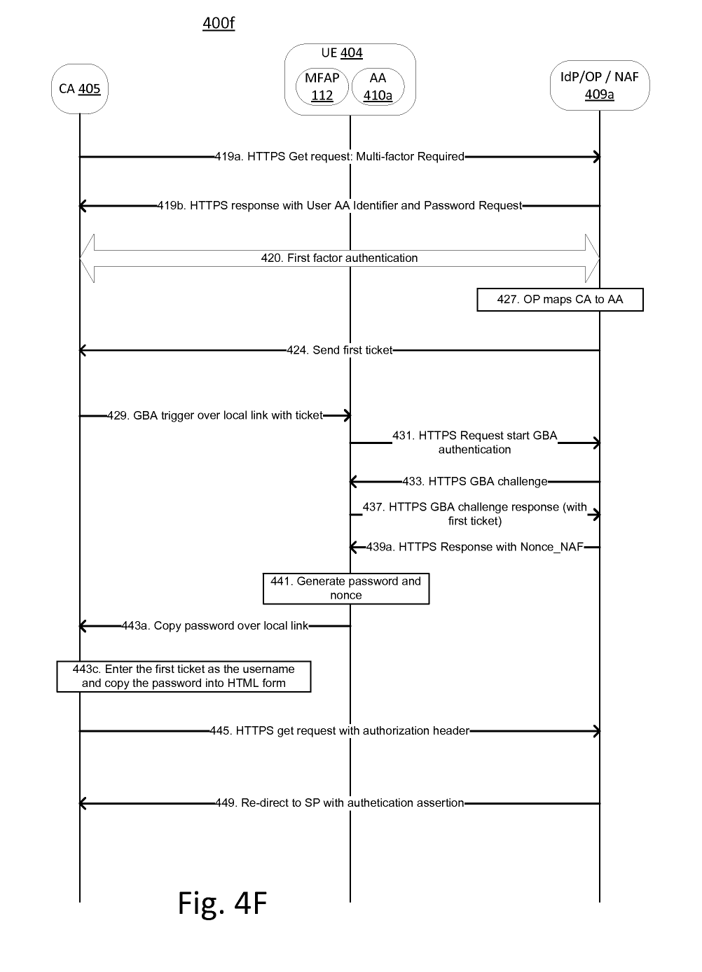

Referring to FIG. 4A, an OID-GBA system 400a is used to provide three-factor authentication in accordance with an example embodiment. The OID-GBA system 400 includes a UE 404, a first AA 410a that resides on the UE 404, a second AA 410b, a third AA 410c, the MFAP 112 that resides on the UE 404, an over-the-top (OTT) SP 406 (which can also be referred to as a RP 406), a first IdP 409a (which can be referred be a master IdP), a second IdP 409b, and a third IdP 410b. A client agent (CA), such as a browser for example, may also reside on the UE 404.

In accordance with the illustrated embodiment, at 412, a user of the UE 404 requests access to a service (provided by the SP 406) via the UE 404, and in particular the CA of the UE 404. The UE 404 may communicate with the SP 406, and the communication may include a user supplied identifier (ID) that is associated with the user. Based on the user ID, at 414, the SP 406 performs a discovery and associates with the first IdP 409a that is associated with the user ID. The first IdP 409a may perform functionality that is associated with an OpenID Identity Provider (OP) or a network application function (NAF), and thus the first IdP 409a may also be referred to as an OP 409a or a NAF 409a. At 416, in accordance with the illustrated embodiment, the SP 406, for example based on a policy of the SP 406, may determine the level of assurance of the authentication that is required in order for the user to access the requested service that is provided by the SP 406. Based on the assurance level, for example, the SP 406 may determine that a multi-factor authentication is required in order for the user to access the requested service that is provided by the SP 406. The SP 406 may also determine appropriate factors of authentication that should be carried out for the user to access the requested service that is provided by the SP 406. At 418, in accordance with the illustrated embodiment, the UE 404 is redirected to the first IdP 409a, which can also be referred to as the OP 409a, via an OpenID authentication request. The SP 406 may also communicate its assurance level requirement to the UE 404. Further, at 418, the services of the MFAP 112 are invoked, for example, as described with respect to FIGS. 1 and 3. At 420, the UE 404, in particular the first AA 310a, and the first IdP 309a carry out a first authentication. The first authentication can authenticate the user using a first authentication factor. The first authentication factor can include a user name and password that is associated with the first IdP 309a. For example, the user can enter the username and the password at the UE 404, and the first IdP 309a can verify the username and password. Alternatively, if a local authentication is being carried out, for example, the local authentication agent (the first AA 410a) may verify the username and password without the involvement of the IdP 409a. A local authentication may refer to an authentication that is performed by the UE 404. Thus, in accordance with the illustrated embodiment, the first authentication is an authentication of the user. At 422, in response to the first authentication, the first IdP 409a generates a first ticket if the first authentication was successful. For example, the first ticket may indicate that the first factor authentication was successful. At 424, in accordance with the illustrated embodiment, the first ticket, which represents proof that a successful authentication was carried out, is sent to the UE 404. The first ticket may include its associated freshness level. At 426, the UE 404 stores the first ticket. At 428, the first IdP 409a stores the first ticket. Alternatively, it will be understood that if the user is locally authenticated by the AA 410a, and if the local authentication was successful, the AA 410a may generate the first ticket and transmit the first ticket to the MFAP 112 such that it is only stored at the MFAP 112. Thus, the MFAP 112, via a local link for example, may receive an assertion representative of a successful authentication by the AA 410a.

With continuing reference to FIG. 4A, in accordance with the illustrated embodiment, at 430, the second AA 410b and the second IdP 409b carry out a second authentication. The second authentication may comprise an authentication of the user of the UE 404 (e.g., a biometric of the user), an authentication of the UE 404, an authentication of a device that is associated with the CA of the UE 404, or the like. A ticket, such as a second ticket for example, may be generated, at 432, by the second IdP 409b upon a successful authentication. At 434, the second ticket is sent to the second AA 410b in accordance with the illustrated embodiment. The ticket that is generated by the second IdP 409b may be sent to the second AA 410b in a secure manner. Alternatively, the second ticket may be generated by the second AA 410b using similar mechanisms used by the second IdP 410b to generate the second ticket. Regardless, at the end of the second authentication, both the second AA 410b and the second IdP 409b may have proof of the second authentication, and the proof is referred to as the second ticket in accordance with FIG. 4A. Alternatively, if a local authentication is carried out by the second AA 410b, for example, the AA 410b may generate the second ticket. At 436, the second AA 410b may send a response to the UE 404, and in particular to the MFAP 112. The response may include the second ticket. The response is sent via a communication link that connects the second AA 410b with the UE 404, such as via a local link for example. At 438, at the network-side, the second IdP 409b may send the second ticket and its associated freshness (e.g., date/time of when the authentication was carried out) to the first IdP 409a. At 440 and 442, the second ticket is stored at the UE 404 and the first IdP 409a, respectively. Alternatively, if a local authentication is carried, for example, the second ticket may is only at the MFAP 112 in accordance with an example embodiment.

Still referring to FIG. 4A, in accordance with the illustrated embodiment, at 444, the third AA 410c and the third IdP 409c carry out a third authentication. The third authentication may comprise an authentication of the user of the UE 404 (e.g., a biometric of the user, behavioral characteristics of the user), an authentication of the UE 404, an authentication of a device that is associated with the CA of the UE 404, or the like. A ticket, such as a third ticket for example, may be generated, at 446, by the third IdP 409c upon a successful authentication. At 448, the third ticket is sent to the third AA 410c in accordance with the illustrated embodiment. The ticket that is generated by the third IdP 409c may be sent to the third AA 410c in a secure manner. Alternatively, the third ticket may be generated by the third AA 410c using similar mechanisms used by the third IdP 410c to generate the third ticket. Regardless, at the end of the third authentication, both the third AA 410c and the third IdP 409c may have proof of the third authentication, and the proof is referred to as the third ticket in accordance with FIG. 4A. Alternatively, if a local authentication is carried out, for example, it is possible that the third ticket is only stored at the third AA 410c that generated the third ticket in accordance with an example embodiment. At 450, the third AA 410c may send a response to the UE 404, and in particular to the MFAP 112. The response may include the third ticket. Thus, the MFAP 112, via a local link for example, may receive an assertion representative of a successful authentication by the AA 410c. The response is sent via a communication link that connects the third AA 410c with the UE 404, such as via a local link for example. At 452, at the network-side, the third IdP 409b may send the third ticket and its associated freshness (e.g., date/time of when the authentication was carried out) to the first IdP 409a. Alternatively, it will understood that if the third AA 410c generated the third ticket, for example, the ticket is not transferred form the third IdP 409c to the master IdP 409a in accordance with an example embodiment. At 454 and 456, the third ticket is stored at the UE 404 and the first IdP 409a, respectively. In an alternative embodiment, the third ticket may be only stored at the MFAP 112 on the UE 404.

At 458, the UE 404, for example the CA of the UE 404, sends the first, second, and third tickets to the first IdP 409a. The UE 404 may further transmit an assurance level and the freshness associated with each of the authentications to the first IdP 409a. At 460, the first IdP 409a compares the first, second, and third tickets that it received from the UE 404 to the first, second, and third tickets, respectively, that are stored at the first IdP 409a. For example, if the first tickets match each other, the second tickets match each other, and the third tickets match each other, the first IdP 409a can verify the illustrated three-factor authentication. Thus, at 462, if the tickets are verified, the first IdP 409a creates a three-factor assertion and sends the three-factor assertion to the SP 406. The assertion that is sent may include the assurance level and the freshness level that was achieved by the multi-factor authentication that was performed. The SP 406 can verify the assertion to allow the UE 404 access to the requested service. Alternatively, if only local authentications were carried out, for example, the MFAP 112 of the UE 404 may send the tickets and assertion directly to the SP 406.

FIG. 4B is another flow diagram that shows another example of using the OID-GBA system 400. In FIG. 4B, the OID-GBA system 400 is used to provide a two-factor authentication. Besides depicting a two-factor authentication instead of three-factor authentication, FIG. 4B also depicts additional detail as compared to FIG. 4A, as described below. In accordance with the illustrated embodiment, a username and a cryptographic value are obtained as part of the first-factor authentication, and a password is obtained for the second-factor authentication. The illustrated UE 404, which may be a mobile terminal for example, includes the CA (Browser Agent) and the MFAP 112. In accordance with the illustrated embodiment, the AA 410b is implemented by a UICC, and the first AA 410a uses user input to authenticate the user of the UE 404.

Referring to FIG. 4B, at 412, a user using the UE 404 request access to services offered by the OTT SP 406. In accordance with the illustrated embodiment, the user requests access using the user's identity that is associated with the IdP/OP 409a. At 414, the SP 406, based on the user's identity, performs a discovery and association with the IdP/OP/NAF 409a. At 416, for example based on policies of the SP 406 and the services requested by the user, the SP 406 determines an appropriate assurance level for the user to access the requested services. For example, at 416, the SP 406 may determine that multiple authentication factors should be performed in order to achieve the appropriate assurance level. In accordance with the illustrated embodiment, at 418, the UE 404 is redirected to the first IdP 409a, which can also be referred to as the OP 409a or the NAF 409a, via an OpenID authentication request. The SP 406 may also communicate its assurance level requirement to the UE 404. The assurance level may be stored at the MFAP 112. At 419a, the UE 404 sends an HTTPS Get request to the OP 409a. The request includes an indication that multi-factor authentication is required. At 419b, the OP 409a provides an HTTPS response to the UE 404. The response includes a request for an identifier of an authentication agent that can authenticate the user of the UE. Alternatively, if an identifier was presented earlier by the user to the SP 406 for example, the preceding step may be skipped. In some cases, at 419b, a secondary identifier may be provided by the user or UE 404 to the IdP/OP/NAF 409a. The response may further include a request for a user password. In accordance with the illustrated embodiment, an AA that may authenticate the user is the first AA 410a, which may reside on the UE 404. At 421, the UE 404 provides a HTTPS Get request that may include the identifier of the first AA 410a, a digest of the password, and a freshness value that is associated with password. Alternatively, if a local authentication is being carried out for example, the user may provide a username and password to the AA 410a on the UE 404. In this case, the steps 419-424 may be skipped. At 422, in accordance with the illustrated embodiment shown in FIG. 4B, the OP 409a generates a first ticket in response to the user being authenticated. For example, the first ticket may indicate that the first factor authentication was successful. At 424, in accordance with the illustrated embodiment, the first ticket, which represents proof that a successful authentication was carried out, is sent to the UE 404. Alternatively, if a local authentication is carried out for example, the first ticket is issued by the AA 410a. The ticket is then stored on the MFAP 112 and an associated freshness or timestamp information may also be stored by the MFAP 112. In accordance with the illustrated embodiment shown in FIG. 4B, at 424, the first ticket is sent with an HTTPS response message that requests an identifier for a second authentication using a second authentication factor. The first ticket may include its associated freshness level.

Still referring to FIG. 4B, at 425, the MFAP 112 may send the identifier associated with a second factor of authentication to the IdP/OP/NAF 409a. The identifier may represent a UE identity (ID), a biometric ID, or any other identity associated with the second factor. Alternatively, if a local authentication is being carried out, the MFAF 112 initiates a local authentication with the appropriate local authentication agent, which is illustrated as the second AA 410b. At 427, an identity of the client agent of the UE 404 is mapped to an authentication agent, which is illustrated as the second AA 410b. This mapping may be accomplished by performing a database query to determine the appropriate AA that is associated with the user and the second factor identifier provided by the MFAP at 425. At 429, the IdP/OP/NAF 409a initiates a push message in order to trigger a GBA authentication using the appropriate AA 410b. Alternatively, the push message may be sent to the MFAP 112 on the UE 404, which then may set-up a secure tunnel link between the MFAP 112 and the AA 410b (step 429b). At 429b, the UE 404 may write the URL of the IdP/OP/NAF 409a to the second AA 410b. The second AA 410b initiates the GBA authentication process with the NAF 409a, at 431. At 433, the IdP/OP/NAF 409a issues a GBA challenge to the second AA 410b. At 435, GBA boot-strapping is performed between the second AA 410b and a bootstrapping server function (BSF) 411. At 437, the second AA 410b responds to the challenge with a bootstrapping identity. At 439, the NAF 409a retrieves keys and authenticates the user with the BSF 411.

With continuing reference to FIG. 4B, once a successful authentication is carried out by the AA 410b, the AA 410b generates a nonce, illustrated as NonceAA, and a session ID. The NonceAA may be a cryptographic value, such as, for example, a cryptographic key, a digital signature, or a temporary identity. The temporary identity may be associated with an authentication or domain. Example temporary identities include a B-TID, a one-round trip authentication (ORTA) ID, an enhanced master session key (MSK) name, or the like. The session ID may be a unique identity that identifies the channel or flow or session. For example, the session ID may be a TLS channel ID, an HTTP session ID, an EAP session ID, or the like. In accordance with the illustrated embodiment, at 443a, the AA 410b sends the session ID and the NonceAA, to the CA of the UE 404, within a HTTP session by copying the session ID and the NonceAA with a “username” field and a “password” field, respectively. It will be understood that other protocols besides HTTP may be used, and the other protocols may not use usernames and passwords. Thus, at 443b, the NonceAA and password is sent to the CA from the second AA 410b. The MFAP 112 stores the first ticket that was issued by the first AA 410a. The MFAP 112 may store the NonceAA and the session ID issued by the AA 410b. Thus, the first factor authentication may be bound, for example cryptographically bound, to the session ID associated with the first factor authentication. In an example embodiment, each factor of authentication, for instance each ticket that results from each factor of authentication, in a multi-factor authentication is bound to a respective session ID. For example, the first ticket may be bound to a session identity (ID) representative of the first factor authentication, a second ticket may be bound to a session ID representative of a second factor authentication, and a third ticket may be found to a session ID representative of a third factor authentication. At 445, in accordance with the illustrated embodiment, the MFAP 112 sends the first ticket to the IdP/OP/NAF 409a. At 447, the IdP/OP/NAF 409a verifies the ticket, the NonceAA, and the session ID to authenticate the user and the CA of the UE 404. For example, the IdP/OP/NAF 409a may generate the NonceAA and the session ID based on the ticket, and the IdP/OP/NAF may compare the generated NonceAA and session ID with the NonceAA and session ID that it obtained as part of the GBA process. At 449 and 451, if the user/CA is authenticated, the IdP/OP/NAF 409a sends an assertion using a HTTP-redirect message to the SP 406 via the UE 404. Alternatively, if only local authentications were carried out for example, the MFAP 112 may send the ticket, the NonceAA, and the session ID to the SP 406. In other cases, a combined assertion that combines all the authentication results is sent to the SP 406 by the MFAP 112. The combined assertion may cryptographically bind each of the one or more session identities (IDs) together. Further, the combined assertion may include an assurance level and a freshness value that correspond to the combined assertion. At 453, the assertion that the SP 406 receives is verified by the SP 406. For example, if the assertion at least meets the authentication requirements (e.g., assurance level) of the SP 406, the user is granted access to the requested service.

Referring to FIG. 4C, an OID-GBA system 400c is used to provide two-factor authentication in accordance with an example embodiment in which a client agent (CA) 405, which can also be referred to as a browser agent (BA) 405, is separate from the UE 404. Thus, the call flow illustrated in FIG. 4C represents an example split-terminal implementation. The OID-GBA system 400.

Still referring to FIG. 4C, at 419a, an initial HTTPS request is sent following an OpenID redirect. At 419b, an HTTPS Unauthorized Response is sent to the CA 405. At 420, in accordance with the illustrated embodiment, the user proceeds with a first factor authentication to the OP 409a (e.g., using a user ID and password). The permissible freshness of the password may be addressed by a policy of the OP 409a. For example, the OP policy may indicate how long a password can be cached in a browser, for instance the CA 405. In an example embodiment, a trusted execution environment, such as a modified UICC for example, enforces such policies. At 427, upon a successful first factor authentication, the OP 409a maps the UE 404, in particular the AA 410a, to the CA 405. At 422, in accordance with the illustrated embodiment, the OP 409a generates a ticket, which can be referred to as a first ticket that represents a successful authentication of the user. At 424, the first ticket is forwarded to the CA 405. The message that is sent at 424 may be protected by HTTPS. At 429, GBA is triggered by a message. At 431, an HTTPS request starts GBA authentication. At 433, an HTTPS GBA challenge is sent to the UE 404. At 437, an HTTPS GBA challenge Response with a bootstrapping identity (B-TID) is sent from the UE 404, for example the first AA 410a, to the NAF/OP 409a. At 439a, the NAF/OP 409a responds with a nonce, such as a Nonce_{NAF} for example. At 441, the AA 410a uses the Nonce_{NAF} to generate a password. At 443a, in accordance with the illustrated embodiment, the password is copied over a local link to the CA 405. At 443a, the first ticket is copied into the username, and the password that was received over the local link is copied into an HTML form. At 445, an HTTP get request with an authorization header is sent to the IdP 409a. The IdP 409a sends a redirect, with an authentication assertion, to an appropriate SP. In an example embodiment, UE 404 can continue to implement the OpenID protocol after the message is sent at 449.

FIG. 4D is a flow diagram for three-factor authentication in which a ticket that is generated during a user authentication is looped through a GBA process in accordance with an example embodiment. Many of the steps that are performed in the illustrated embodiment shown in FIG. 4D are described above with respect to FIG. 4A. Referring to FIG. 4D, the tickets that are generated are presented at the end of the completed authentication by the MFAP 112 to the IdP 409a, at 458. But instead of sending the tickets following each authentication factor, the tickets may be sent after the three-authentication factors are completed, as shown. Alternatively, if each of the authentication factors are carried out locally on the UE 404 for example, the MFAP 112 may the tickets and assertion directly to the SP 406. In an example embodiment, the third ticket is sent after the three-factor authentication is completed because each of the tickets are looped, thereby binding each of the three authentication protocols. FIG. 4E is a flow diagram of the three-factor authentication shown in FIG. 4D, with additional detail depicted. FIG. 4F is a compressed version of the example call flow that is depicted in FIG. 4D.

Referring to FIG. 4E, in accordance with the illustrated embodiment, the messages at 412-421c are substantially the same as the corresponding messages that are described above with reference to FIG. 4D, wherein a user authentication is performed. After the user authentication is performed, a first ticket is generated, at 422, by the IdP/OP/NAF 409a. Further, a request for a second factor authentication is sent out to the MFAF 112. At 425, the MFAP 112 responds to the IdP/OP/NAF 409a with a second authentication factor ID. Using second authentication factor ID, at 427, the OP 409a maps the client agent to the second AA 410b. A session or channel ID from the user authentication may also be mapped to the second AA 410b. At 429a, the IdP/OP/NAF 409a initiates a GBA authentication process with the second AA 410b in order to start a GBA authentication. As part of the message sent by the IdP/OP/NAF 409a to the second AA 410b, at 429a, may be the first ticket that was generated as part of the successful first factor authentication carried out at 422. Alternatively, the GBA authentication trigger message (see 429b and 429c) may be initiated by the MFAP 112, and thus the first ticket may be passed from the MFAP 112 to the second AA 410b as part of messages 429b or 429c.

In accordance with the illustrated embodiment, NAF keys are derived as part of the GBA process at 439, and the first ticket may be bound to the NAF keys, which may also be referred to as GBA-specific keys. The IdP/NAF 409a retrieves the NAF keys from the BSF 411 as part of the GBA process. At 441, the second AA 410b generates the NonceAA, which may represent any random value or cryptographic, generates a password using the NAF keys that were generated as part of the GBA process. The second AA 410b sends the NonceAA and the password, for example using a local link that connects the second AA 410b with the UE 404, to the CA on the UE 404 (see 443b). At 443a, if the AA 410b was on the UE 404 for example, the NonceAA and the password may be copied by the user an HTTP form page on the CA. The NonceAA and the password may be presented to the IdP/OP/NAF 409a at 445. Using the GBA NAF keys obtained at 439, and using the NonceAA and the password generated from the first ticket, the IdP/NAF 409a verifies the password sent by the CA of the UE 404 (see 447). If there is a match, for example, a message containing the authentication assertion is sent by the IdP/NAF/OF 409a to the UE 404, and the message is redirected to the SP 406 (see 449 and 451). If only local authentications were carried out, for example, the MFAP 112 may send the assertion directly to the SP 406 without the assertion being sent to the IdP/NAF/OP 409a. The assertion may contain or indicate the assurance and freshness level information that corresponds to the multi-factor authentication.

Referring to FIG. 4F, at 419a, an initial HTTPS request is sent following an OpenID redirect. At 419b, an HTTPS Unauthorized Response is sent to the CA 405. At 420, in accordance with the illustrated embodiment, the user proceeds with a first factor authentication to the OP 409a (e.g., using a user ID and password). The permissible freshness of the password may be addressed by a policy of the OP 409a. For example, the OP policy may indicate how long a password can be cached in a browser, for instance the CA 405. In an example embodiment, a trusted execution environment, such as a modified UICC for example, enforces such policies. At 427, upon a successful first factor authentication, the OP 409a maps the UE 404, in particular the AA 410a, to the CA 405. At 422, in accordance with the illustrated embodiment, the OP 409a generates a ticket, which can be referred to as a first ticket that represents a successful authentication of the user. As described above, the term ticket, as used herein, may refer to a random value, a cryptographic value, an assertion, or the like. For example, the ticket may represent a digital signature, a cryptographic key, or a temporary identity. At 424, the first ticket is forwarded to the CA 405. The message that is sent at 424 may be protected by HTTPS. At 429, GBA is triggered by a message. At 431, an HTTPS request starts GBA authentication. At 433, an HTTPS GBA challenge is sent to the UE 404. At 437, an HTTPS GBA challenge Response carrying the first ticket with a bootstrapping identity (B-TID) is sent from the UE 404, for example the first AA 410a, to the NAF/OP 409a. Further, at 437, in accordance with the illustrated embodiment shown in FIG. 4F, the NAF/OP 409a receives the first ticket and verifies that the second factor authentication (e.g., UICC-based authentication) is bound to the first factor authentication (e.g., user authentication) from step 420. At 439a, the NAF/OP 409a responds with a nonce, such as a Nonce_{NAF} for example. It will be appreciated that the Nonce_{NAF} may be a random or cryptographic value such as, for example, a digital signature, a cryptographic key, or a temporary identity. At 441, the AA 410a generates a password and a Nonce_{AA}. At 443a, in accordance with the illustrated embodiment, the password is copied over a local link to the CA 405. At 443a, the first ticket is copied into the username, and the password that was received over the local link is copied into an HTML form. At 445, an HTTP get request with an authorization header is sent to the IdP 409a. The IdP 409a sends a redirect, with an authentication assertion, to an appropriate SP. In an example embodiment, UE 404 can continue to implement the OpenID protocol after the message is sent at 449.

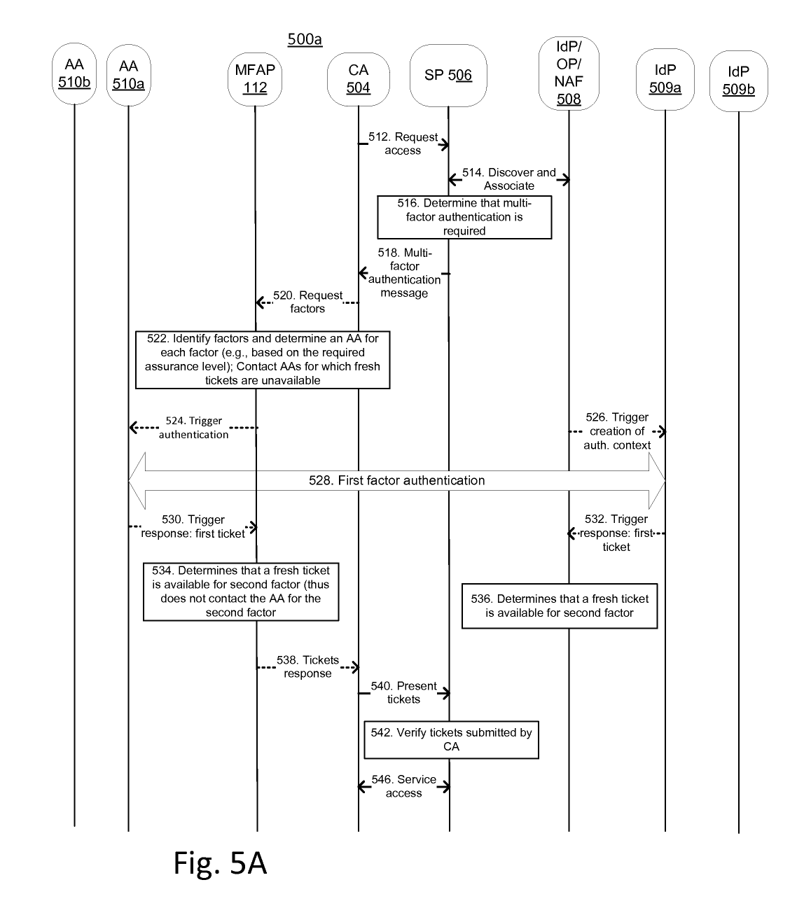

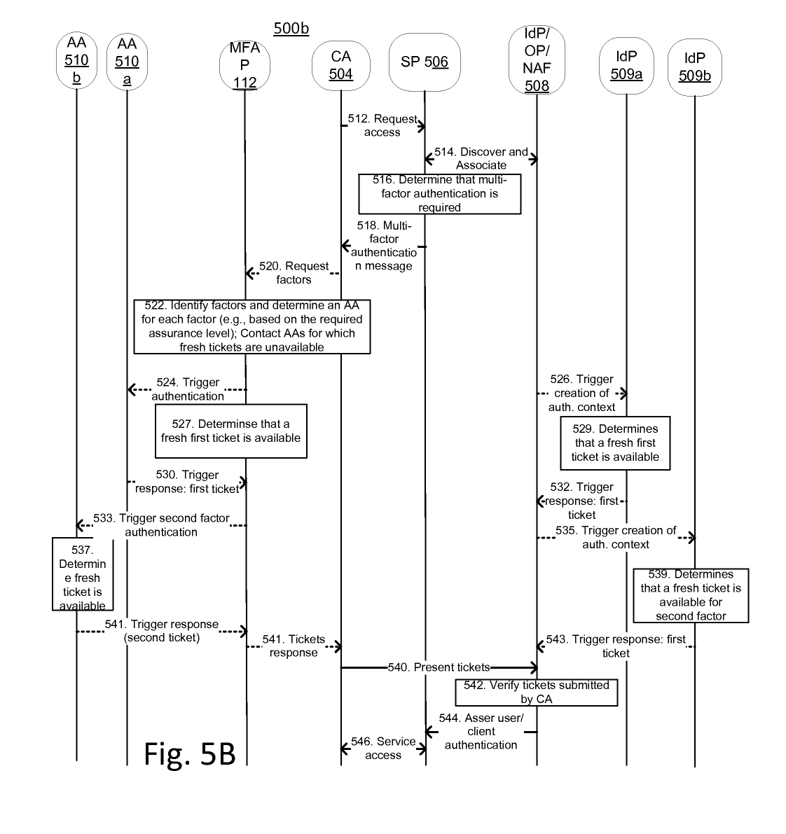

FIG. 5A is a flow diagram in which a fresh authentication result is asserted in accordance with an example embodiment. Referring to FIG. 5A, an example authentication system 500a includes one or more authentication agents, for instance a first AA 510a and a second AA 510b, a CA 504, a SP 506, a master IdP 508, and the MFAP 112. While two authentication agents are illustrated in the authentication system 500a, it will be understood that the number of authentication agents in the authentication system 300 may vary as desired. In accordance with the illustrated embodiment, the first authentication agent 510a and the second authentication agent 510b are associated with a first IdP 509a and a second IdP 509b, respectively. Further, the authentication agents 510a and 510b and the identity providers 509a and 509b can enable a two-factor authentication so that the CA 504 can be provided with access to services offered by the SP 506. The SP 506, the master IdP 508, the first IdP 509a, and the second IdP 509b, may collectively be referred to as the network-side of the authentication system 500. The SP 506 may also be referred to as a relying party (RP) 506, without limitation. Although an example two-factor authentication is illustrated in FIG. 5A, it will be understood that the call flow shown in FIG. 5A may be extended for an authentication that uses more than two-factors. In accordance with the illustrated embodiment, the policies at the SP 506 and the resulting requirements provided by the SP 506 to the CA 504 and MFAP 112 deem that the second factor was fresh, and thus did not need to be carried out again. Instead of carrying out the second factor authentication, for example, the result of an earlier authentication is used to assert that the second factor has been authenticated. The first factor may have been deemed to be stale, and thus is carried out in accordance with the illustrated embodiment.

Still referring to FIG. 5A, at 512, a user requests access to a service (provided by the SP 306) via the CA 504. The CA 504 may communicate with the SP 506, and the communication may include a user ID that is associated with the user. Based on the user ID, at 514, the SP 506 performs a discovery and associates with the master IdP 508 that is associated with the user ID. The master IdP 508 may perform functionality that is associated with an OpenID Identity Provider (OP) or a network access function (NAF), and thus the master IdP 508 may also be referred to as an OP 508 or a NAF 508. At 516, in accordance with the illustrated embodiment, the SP 506, for example based on a policy of the SP 506, determines that a multi-factor authentication is required in order for the user to access the requested service that is provided by the SP 506. The SP 506 may also determine the level of assurance of the authentication that is required in order for the user to access the requested service that is provided by the SP 506. At 518, in accordance with the illustrated embodiment, the SP 506 communicates its assurance level requirement to the CA 504. At 520, the CA 504 invokes services of the MFAP 512. Alternatively, the SP 506 may communicate, to the IdP/OP/NAF 508, the assurance level required for the user to access the service provided by the SP 506. The IdP/OP/NAF 508 may determine the corresponding authentication factors that will have to be carried out based on the require assurance level. The CA 504 may trigger the MFAP 112, which can be an application on the UE. For example, the application may be triggered as an intent with a platform, such as an Android platform for example. The CA 504 may provide a list of authentication factors to the MFAP 112.

At 522, based on the level of assurance that is required to access the service, for example, the MFAP 112 determines the types and strengths of the authentication factors that can be performed to achieve the required assurance level. The MFAP 112 may further identify authentication agents that can perform the required authentications. For example, in accordance with the illustrated embodiment, the MFAP 112 determines that the first AA 510a and the second AA 510 are associated with the determined types and strengths of authentication factors. After the first authentication agent 510a is identified, at 524, the MFAP 112 sends a trigger to the first authentication agent 510a so that that the first authentication agent 510a initiates an authentication protocol. At 526, the master IdP 508 triggers a process in which a context is created for the authentication protocol that is initiated by the first authentication agent 510a. For example, the master IdP 508 may communicate with the first IdP 509a that is associated with the first AA 510a to request that the first IdP 309a create a context for the first AA-initiated authentication. The steps performed at 524 and 526 may be performed in parallel with each other.

With continuing reference to FIG. 5A, in accordance with the illustrated embodiment, at 528, the first AA 510a and the first IdP 509a carry out an authentication. The authentication may comprise an authentication of the user of the CA 504 (e.g., a biometric of the user), of the CA 504, of a device that is associated with the CA 304, or the like. A ticket, such as a first ticket for example, may be generated by the first IdP 509a upon a successful authentication. The first ticket is sent to the first authentication agent 510a in accordance with the illustrated embodiment. The ticket that is generated by the first IdP 509a may be sent to the first AA 510a in a secure manner. Alternatively, the first ticket may be generated by the first AA 510a using similar mechanisms used by the first IdP 510b to generate the first ticket. Regardless, at the end of the authentication, both the first AA 510a and the first IdP 509a may have proof of the authentication, and the proof is referred to as the first ticket in accordance with FIG. 5A.

At 530, in response to the trigger that was received at 524, the first AA 510a may send a trigger response that comprises the first ticket. The trigger response may be sent to the MFAP 112, and the trigger response may prove that a successful authentication was performed. At 532, at the network-side, the first IdP 309a may send the first ticket and its associated freshness (e.g., date/time of when the authentication was carried out) to the master IdP 308.

In accordance with the illustrated example embodiment, at 534, based on policies for example, the MFAP 112 determines that a fresh ticket is available that corresponds to the second factor authentication. For example, the MFAP 112 may determine that a ticket, for example a second ticket, has not expired, and thus can be used to assert that the second factor has been authenticated. For example, the MFAP may identify a time-stamp on the ticket and determine that the time-stamp complies with a requirement of the SP. Thus, the MFAP 112 does not contact the second AA 510b. At 536, the master IdP 508 determines that a fresh ticket (e.g., the second ticket) is available that corresponds to the second factor. At 538, the MFAP 112 consolidates the first ticket and the second ticket. The MFAP may further compute an aggregate achieved assurance level and freshness level for the CA 504. At 540, the CA 504 may present the first and second tickets to the master IdP 508 (see FIG. 5B). The CA 504 may further transmit achieved assurance level and the freshness associated with each of the authentications to the master IdP 508. Alternatively, referring again to FIG. 5A, the CA 504 may present the tickets directly the SP 506. At 542, the master IdP 508 (or the SP 506) compares the first and second tickets that it received from the CA 504 to the first and second tickets it previously possessed. At 544, if both of the first tickets match each other and both of the second tickets match each other, for example, the master IdP 508 (or the SP 506) creates an assertion. The assertion is sent to the SP 506. The assertion that is sent may include the assurance level and the freshness level that was achieved by the multi-factor authentication that was performed. At 546, in accordance with the illustrated embodiment, the SP 606 verifies the assertion and provides a success message to the CA 504, thereby by providing the CA 504 and the user of the CA 504 with access to the requested service provided by the SP 506.

Alternatively, in some cases, only the assurance level requested by the SP 506 is provided to the MFAP 112. Thus, at 522, the MFAP determines the factors and the corresponding authentication agents that may be invoke to achieve the required assurance levels. At 524, in accordance with the illustrated embodiment, the MFAP 112 communicates with the first AA 510a, which can be referred to as a local factor AA because it performs a local authentication, in order to trigger the first authentication. For example, if an AA is a local factor AA, it may interact with a user to obtain a username/password. Further, a local factor AA may instruct a user to use a finger-print reader, or the local factor AA may analyze behavioral characteristics of the user, authenticate a device possessed by the user, or the like. Alternatively, part of the authentication may be carried out at the network-side, by using the services of the IdP 509a for example. In a local factor authentication scenario, a first ticket is generated by the AA 510a and sent to the MFAP 112. Alternatively, the first ticket may be generated by the IdP 509a and sent to the IdP/NAF/OP 508. Once the first authentication using the first authentication factor is carried out, in accordance with the illustrated embodiment, the MFAP 112 determines that the second factor need not be carried out because there is an existing fresh second factor authentication that was carried out with a timestamp that has not been determined to be stale. At 538, the second ticket associated with the second factor is released by the MFAP 112 in addition to the first ticket associated with the first factor of authentication that was obtained at 530. At 540, both the tickets and a signed assertion may be released in a secure manner to the SP 506 by the MFAP 112 (via the CA 504). At 542, the tickets are verified by the SP 506 using cryptographic means and access is provided to the user at 544. Alternatively, at 540, the tickets may be presented by the CA 504 to the IdP/OP 508. In such a case, the IdP/NAF/OP 508 verifies the tickets and creates an assertion that is sent to the SP 506 by the IdP/NAF/OP 508. The SP 506 may verify the signed assertion and provides access to the service.

Referring also to FIG. 5B, multiple fresh authentication results can be asserted in an example system 500b in accordance with an example embodiment. In FIG. 5B, the policies at the SP 506 and the resulting requirements provided by the SP 506 to the CA 504 and the MFAP 112 deem that the earlier authentications (first and second factors) that have been carried out and the results (first and second tickets) stored at the MFAP 112 are fresh enough for the 506. Thus, the authentications protocols are not carried out, and instead the results of the earlier authentication factors are used to assert the authentications to the SP 506.

For example, in accordance with the illustrated example embodiment, at 527, after a first factor authentication is triggered, the first AA 510a determines that a fresh ticket is available that corresponds to the first factor authentication. For example, the first AA 510a may determine that a ticket, for example a first ticket, has not expired, and thus can be used to assert that the first factor has been authenticated. At 529, the first IdP 509a determines that the first ticket is fresh. At 530, the first AA 510a responds to the trigger with a trigger response, which includes the first ticket, which is fresh. Thus, the first fresh ticket is sent to the MFAP 112. At 532, the first IdP 509a sends the first fresh ticket to the master IdP 508, in accordance with the illustrated embodiment. At 523, the MFAP 112 sends a trigger to the second authentication agent 510b so that that the second authentication agent 510b can initiate an authentication protocol. At 535, the master IdP 508 triggers a process in which a context is created for the authentication protocol that can be initiated by the second authentication agent 510b. The steps performed at 533 and 535 may be performed in parallel with each other.

With continuing reference to FIG. 5B, in accordance with the illustrated embodiment, at 537, the second AA 510b determines that a fresh ticket is available that corresponds to the second factor authentication. For example, the second AA 510b may determine that a ticket, for example a second ticket, has not expired, and thus can be used to assert that the second factor has been authenticated. At 539, the second IdP 509b determines that a fresh ticket (e.g., the second ticket) is available that corresponds to the second factor. At 541, the second AA 510b responds to the authentication trigger (at 533) and sends the second ticket to the MFAP 112. At 543, the second IdP 509b responds to the authentication trigger (at 535) and sends the second ticket, which is fresh, to the master IdP 508. At 541, the MFAP 112 consolidates the first ticket and the second ticket. The MFAP may further compute an aggregate achieved assurance level and freshness level for the CA 504. At 540, the CA 504 presents the first and second tickets to the master IdP 508. The CA 504 may further transmit achieved assurance level and the freshness associated with each of the authentications to the master IdP 508. At 542, the master IdP 508 compares the first and second tickets that it received from the CA 504 to the first and second tickets it has received from the first and second IdPs, respectively. At 544, if both of the first tickets match each other and both of the second tickets match each other, for example, the master IdP 508 creates an assertion. The master IdP 508 sends the assertion to the SP 506. The assertion that is sent may include the assurance level and the freshness level that was achieved by the multi-factor authentication that was performed. At 546, in accordance with the illustrated embodiment, the SP 606 verifies the assertion and provides a success message to the CA 504, thereby by providing the CA 504 and the user of the CA 504 with access to the requested service provided by the SP 506.

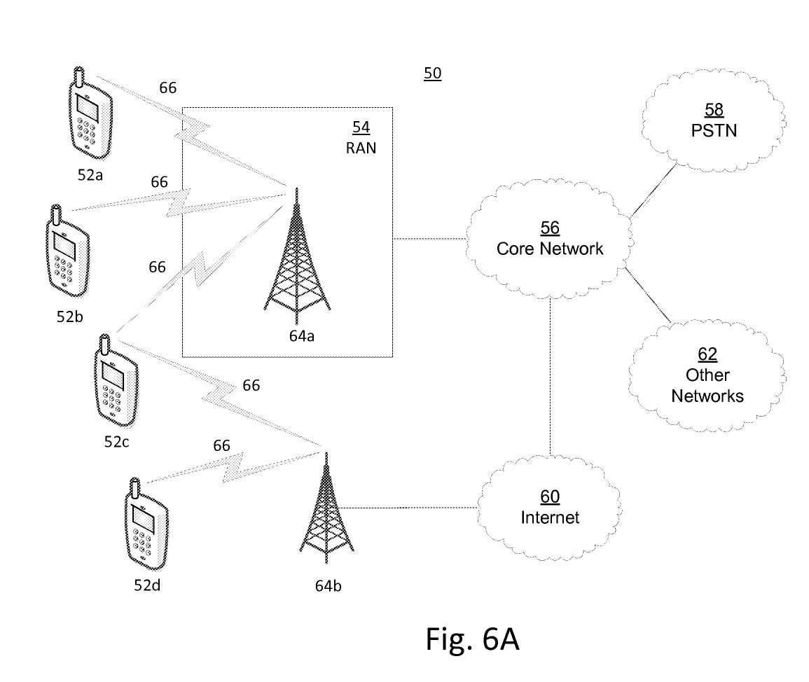

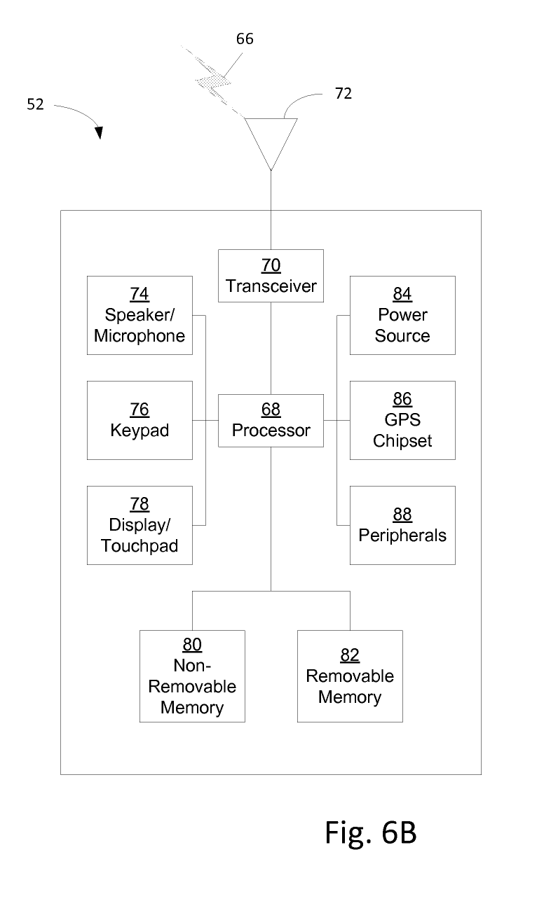

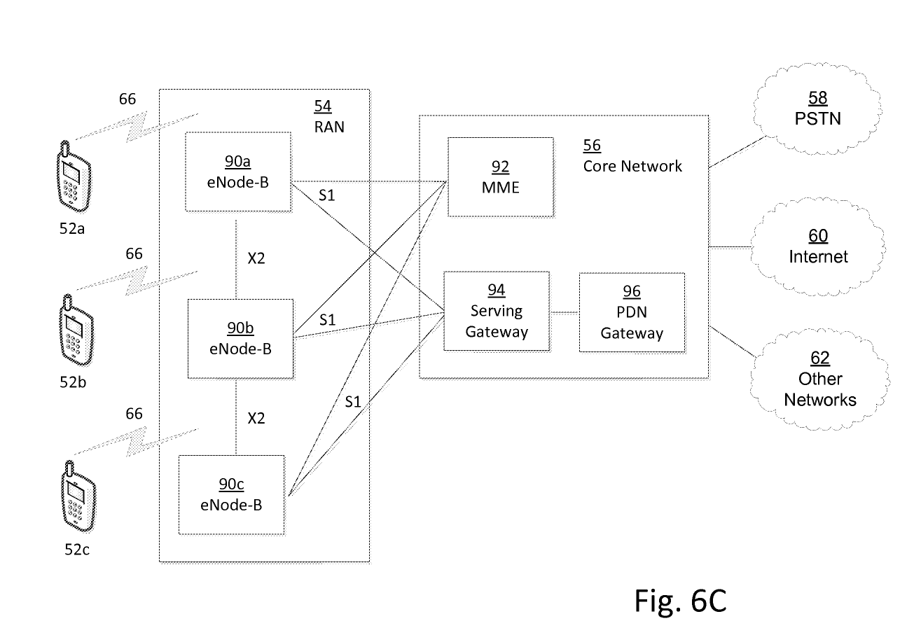

FIG. 6A is a diagram of an example communications system 50 in which one or more disclosed embodiments may be implemented. The communications system 50 may be a multiple access system that provides content, such as voice, data, video, messaging, broadcast, etc., to multiple wireless users. The communications system 50 may enable multiple wireless users to access such content through the sharing of system resources, including wireless bandwidth. For example, the communications systems 50 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 6A, the communications system 50 may include wireless transmit/receive units (WTRUs) 52a, 52b, 52c, 52d, a radio access network (RAN) 54, a core network 56, a public switched telephone network (PSTN) 58, the Internet 60, and other networks 62, though it will be appreciated that the disclosed embodiments contemplate any number of WTRUs, base stations, networks, and/or network elements. Each of the WTRUs 52a, 52b, 52c, 52d may be any type of device configured to operate and/or communicate in a wireless environment. By way of example, the WTRUs 52a, 52b, 52c, 52d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 50 may also include a base station 64a and a base station 64b. Each of the base stations 64a, 64b may be any type of device configured to wirelessly interface with at least one of the WTRUs 52a, 52b, 52c, 52d to facilitate access to one or more communication networks, such as the core network 56, the Internet 60, and/or the networks 62. By way of example, the base stations 64a, 64b may be a base transceiver station (BTS), a Node-B, an eNode B, a Home Node B, a Home eNode B, a site controller, an access point (AP), a wireless router, and the like. While the base stations 64a, 64b are each depicted as a single element, it will be appreciated that the base stations 64a, 64b may include any number of interconnected base stations and/or network elements.

The base station 64a may be part of the RAN 54, which may also include other base stations and/or network elements (not shown), such as a base station controller (BSC), a radio network controller (RNC), relay nodes, etc. The base station 64a and/or the base station 64b may be configured to transmit and/or receive wireless signals within a particular geographic region, which may be referred to as a cell (not shown). The cell may further be divided into cell sectors. For example, the cell associated with the base station 64a may be divided into three sectors. Thus, in an embodiment, the base station 64a may include three transceivers, i.e., one for each sector of the cell. In an embodiment, the base station 64a may employ multiple-input multiple output (MIMO) technology and, therefore, may utilize multiple transceivers for each sector of the cell.

The base stations 64a, 64b may communicate with one or more of the WTRUs 52a, 52b, 52c, 52d over an air interface 66, which may be any suitable wireless communication link (e.g., radio frequency (RF), microwave, infrared (IR), ultraviolet (UV), visible light, etc.). The air interface 66 may be established using any suitable radio access technology (RAT).

More specifically, as noted above, the communications system 50 may be a multiple access system and may employ one or more channel access schemes, such as CDMA, TDMA, FDMA, OFDMA, SC-FDMA, and the like. For example, the base station 64a in the RAN 54 and the WTRUs 52a, 52b, 52c may implement a radio technology such as Universal Mobile Telecommunications System (UMTS) Terrestrial Radio Access (UTRA), which may establish the air interface 816 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 64a and the WTRUs 52a, 52b, 52c may implement a radio technology such as Evolved UMTS Terrestrial Radio Access (E-UTRA), which may establish the air interface 66 using Long Term Evolution (LTE) and/or LTE-Advanced (LTE-A).

In other embodiments, the base station 64a and the WTRUs 52a, 52b, 52c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 64b in FIG. 6A may be a wireless router, Home Node B, Home eNode B, femto cell base station, or access point, for example, and may utilize any suitable RAT for facilitating wireless connectivity in a localized area, such as a place of business, a home, a vehicle, a campus, and the like. In an embodiment, the base station 64b and the WTRUs 52c, 52d may implement a radio technology such as IEEE 802.11 to establish a wireless local area network (WLAN). In an embodiment, the base station 64b and the WTRUs 52c, 52d may implement a radio technology such as IEEE 802.15 to establish a wireless personal area network (WPAN). In yet an embodiment, the base station 64b and the WTRUs 52c, 52d may utilize a cellular-based RAT (e.g., WCDMA, CDMA2000, GSM, LTE, LTE-A, etc.) to establish a picocell or femtocell. As shown in FIG. 6A, the base station 64b may have a direct connection to the Internet 60. Thus, the base station 64b may not be required to access the Internet 60 via the core network 56.

The RAN 54 may be in communication with the core network 56, which may be any type of network configured to provide voice, data, applications, and/or voice over internet protocol (VoIP) services to one or more of the WTRUs 52a, 52b, 52c, 52d. For example, the core network 56 may provide call control, billing services, mobile location-based services, pre-paid calling, Internet connectivity, video distribution, etc., and/or perform high-level security functions, such as user authentication. Although not shown in FIG. 6A, it will be appreciated that the RAN 54 and/or the core network 56 may be in direct or indirect communication with other RANs that employ the same RAT as the RAN 54 or a different RAT. For example, in addition to being connected to the RAN 54, which may be utilizing an E-UTRA radio technology, the core network 56 may also be in communication with another RAN (not shown) employing a GSM radio technology.

The core network 56 may also serve as a gateway for the WTRUs 52a, 52b, 52c, 52d to access the PSTN 58, the Internet 60, and/or other networks 62. The PSTN 58 may include circuit-switched telephone networks that provide plain old telephone service (POTS). The Internet 60 may include a global system of interconnected computer networks and devices that use common communication protocols, such as the transmission control protocol (TCP), user datagram protocol (UDP) and the internet protocol (IP) in the TCP/IP internet protocol suite. The networks 62 may include wired or wireless communications networks owned and/or operated by other service providers. For example, the networks 62 may include another core network connected to one or more RANs, which may employ the same RAT as the RAN 54 or a different RAT.

Some or all of the WTRUs 52a, 52b, 52c, 52d in the communications system 800 may include multi-mode capabilities, i.e., the WTRUs 52a, 52b, 52c, 52d may include multiple transceivers for communicating with different wireless networks over different wireless links. For example, the WTRU 52c shown in FIG. 6A may be configured to communicate with the base station 64a, which may employ a cellular-based radio technology, and with the base station 64b, which may employ an IEEE 802 radio technology.

FIG. 6B is a system diagram of an example WTRU 52. As shown in FIG. 6B, the WTRU 52 may include a processor 68, a transceiver 70, a transmit/receive element 72, a speaker/microphone 74, a keypad 76, a display/touchpad 78, non-removable memory 80, removable memory 82, a power source 84, a global positioning system (GPS) chipset 86, and other peripherals 88. It will be appreciated that the WTRU 52 may include any sub-combination of the foregoing elements while remaining consistent with an embodiment.

The processor 68 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 68 may perform signal coding, data processing, power control, input/output processing, and/or any other functionality that enables the WTRU 52 to operate in a wireless environment. The processor 68 may be coupled to the transceiver 70, which may be coupled to the transmit/receive element 72. While FIG. 6B depicts the processor 68 and the transceiver 70 as separate components, it will be appreciated that the processor 68 and the transceiver 70 may be integrated together in an electronic package or chip. The processor 68 may perform application-layer programs (e.g., browsers) and/or radio access-layer (RAN) programs and/or communications. The processor 68 may perform security operations such as authentication, security key agreement, and/or cryptographic operations, such as at the access-layer and/or application layer for example.

The transmit/receive element 72 may be configured to transmit signals to, or receive signals from, a base station (e.g., the base station 64a) over the air interface 66. For example, in an embodiment, the transmit/receive element 72 may be an antenna configured to transmit and/or receive RF signals. In an embodiment, the transmit/receive element 72 may be an emitter/detector configured to transmit and/or receive IR, UV, or visible light signals, for example. In yet an embodiment, the transmit/receive element 72 may be configured to transmit and receive both RF and light signals. It will be appreciated that the transmit/receive element 72 may be configured to transmit and/or receive any combination of wireless signals.

In addition, although the transmit/receive element 72 is depicted in FIG. 6B as a single element, the WTRU 52 may include any number of transmit/receive elements 72. More specifically, the WTRU 52 may employ MIMO technology. Thus, in an embodiment, the WTRU 52 may include two or more transmit/receive elements 72 (e.g., multiple antennas) for transmitting and receiving wireless signals over the air interface 66.

The transceiver 70 may be configured to modulate the signals that are to be transmitted by the transmit/receive element 72 and to demodulate the signals that are received by the transmit/receive element 72. As noted above, the WTRU 52 may have multi-mode capabilities. Thus, the transceiver 70 may include multiple transceivers for enabling the WTRU 52 to communicate via multiple RATs, such as UTRA and IEEE 802.11, for example.

The processor 68 of the WTRU 52 may be coupled to, and may receive user input data from, the speaker/microphone 74, the keypad 76, and/or the display/touchpad 78 (e.g., a liquid crystal display (LCD) display unit or organic light-emitting diode (OLED) display unit). The processor 68 may also output user data to the speaker/microphone 74, the keypad 76, and/or the display/touchpad 78. In addition, the processor 818 may access information from, and store data in, any type of suitable memory, such as the non-removable memory 80 and/or the removable memory 82. The non-removable memory 80 may include random-access memory (RAM), read-only memory (ROM), a hard disk, or any other type of memory storage device. The removable memory 82 may include a subscriber identity module (SIM) card, a memory stick, a secure digital (SD) memory card, and the like. In other embodiments, the processor 818 may access information from, and store data in, memory that is not physically located on the WTRU 52, such as on a server or a home computer (not shown).

The processor 68 may receive power from the power source 84, and may be configured to distribute and/or control the power to the other components in the WTRU 52. The power source 84 may be any suitable device for powering the WTRU 52. For example, the power source 84 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 68 may also be coupled to the GPS chipset 86, which may be configured to provide location information (e.g., longitude and latitude) regarding the current location of the WTRU 52. In addition to, or in lieu of, the information from the GPS chipset 86, the WTRU 52 may receive location information over the air interface 816 from a base station (e.g., base stations 64a, 64b) and/or determine its location based on the timing of the signals being received from two or more nearby base stations. It will be appreciated that the WTRU 52 may acquire location information by way of any suitable location-determination method while remaining consistent with an embodiment.

The processor 68 may further be coupled to other peripherals 88, which may include one or more software and/or hardware modules that provide additional features, functionality and/or wired or wireless connectivity. For example, the peripherals 88 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 6C is a system diagram of the RAN 54 and the core network 806 according to an embodiment. As noted above, the RAN 54 may employ a UTRA radio technology to communicate with the WTRUs 52a, 52b, 52c over the air interface 66. The RAN 54 may also be in communication with the core network 806. As shown in FIG. 6C, the RAN 54 may include Node-Bs 90a, 90b, 90c, which may each include one or more transceivers for communicating with the WTRUs 52a, 52b, 52c over the air interface 66. The Node-Bs 90a, 90b, 90c may each be associated with a particular cell (not shown) within the RAN 54. The RAN 54 may also include RNCs 92a, 92b. It will be appreciated that the RAN 54 may include any number of Node-Bs and RNCs while remaining consistent with an embodiment.

As shown in FIG. 6C, the Node-Bs 90a, 90b may be in communication with the RNC 92a. Additionally, the Node-B 90c may be in communication with the RNC 92b. The Node-Bs 90a, 90b, 90c may communicate with the respective RNCs 92a, 92b via an Iub interface. The RNCs 92a, 92b may be in communication with one another via an Iur interface. Each of the RNCs 92a, 92b may be configured to control the respective Node-Bs 90a, 90b, 90c to which it is connected. In addition, each of the RNCs 92a, 92b may be configured to carry out and/or support other functionality, such as outer loop power control, load control, admission control, packet scheduling, handover control, macrodiversity, security functions, data encryption, and the like.

The core network 806 shown in FIG. 6C may include a media gateway (MGW) 844, a mobile switching center (MSC) 96, a serving GPRS support node (SGSN) 98, and/or a gateway GPRS support node (GGSN) 99. While each of the foregoing elements are depicted as part of the core network 56, it will be appreciated that any one of these elements may be owned and/or operated by an entity other than the core network operator.

The RNC 92a in the RAN 54 may be connected to the MSC 96 in the core network 56 via an IuCS interface. The MSC 96 may be connected to the MGW 94. The MSC 96 and the MGW 94 may provide the WTRUs 52a, 52b, 52c with access to circuit-switched networks, such as the PSTN 58, to facilitate communications between the WTRUs 52a, 52b, 52c and traditional land-line communications devices.

The RNC 92a in the RAN 54 may also be connected to the SGSN 98 in the core network 806 via an IuPS interface. The SGSN 98 may be connected to the GGSN 99. The SGSN 98 and the GGSN 99 may provide the WTRUs 52a, 52b, 52c with access to packet-switched networks, such as the Internet 60, to facilitate communications between and the WTRUs 52a, 52b, 52c and IP-enabled devices.

As noted above, the core network 56 may also be connected to the networks 62, which may include other wired or wireless networks that are owned and/or operated by other service providers.

Although features and elements are described above in particular combinations, each feature or element can be used alone or in any combination with the other features and elements. Additionally, the embodiments described herein are provided for exemplary purposes only. For example, while embodiments may be described herein using OpenID and/or SSO authentication entities and functions, similar embodiments may be implemented using other authentication entities and functions. Furthermore, the embodiments described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A user equipment (UE) comprising a multi-factor authentication proxy (MFAP) that operates to:
determine that multiple authentication factors are required to authenticate a user of the UE for access to a service provided by a service provider (SP);
identify an authentication agent (AA) on a different device than the UE to perform an authentication utilizing one of the required authentication factors;
establish a local link to the different device;
trigger the AA to perform the authentication; and
receive, via the local link, an assertion representative of a successful authentication by the AA.

2. The UE as recited in claim 1, wherein the MFAP further operates to identify one or more additional authentication agents on the UE to perform authentication utilizing at least one other of the required authentication factors.

3. The UE as recited in claim 1, wherein the MFAP further operates to identify one or more additional authentication agents on a second different device from the UE to perform authentication utilizing at least one other of the required authentication factors, and wherein the MFAP communicates with the one or more additional authentication agents via a local link or a remote link.

4. The UE as recited in claim 1, wherein the MFAP further operates to send the assertion representative of a successful authentication directly to the SP.

5. In a system comprising a first user equipment (UE), a service provider (SP), and a multi-factor authentication proxy (MFAP), a method performed by the MFAP, the method comprising:
based on a policy of the SP, determining that a multi-factor authentication is required for a user of the first UE to access a service that is provided by the SP;
identifying a first authentication agent to perform a first factor authentication;
triggering the first factor authentication that results in a first ticket;
identifying a second authentication agent to perform a second factor authentication;
triggering the second factor authentication that results in a second ticket;
sending the first and second tickets to a first client agent of the first UE, thereby enabling the first UE to access the service that is provided by the SP.

6. The method as recited in claim 6, wherein the user of the first UE transitions to a second client agent by leveraging an authentication of the first client agent.

7. The method as recited in claim 6, wherein the second client agent resides on the first UE or a second UE that is different than the first UE.

8. The method as recited in claim 5, where in the first ticket is bound to a session identity representative of the first factor authentication.

9. The method as recited in claim 5, wherein the MFAP resides on the first UE.

10. The method as recited in claim 9, wherein the MFAP communicates with the second client agent of the second UE via a local link or a remote link.

11. The method as recited in claim 5, wherein the MFAP resides on a second UE, and wherein the MFAP communicates with the first client agent of the first UE via a local link or a remote link.

12. The method as recited in claim 5, wherein the first and second tickets each comprise at least one of a digital signature, a cryptographic value, a random value, or a temporary identity.

13. The method as recited in claim 5, wherein at least one of the first and second authentication agents reside on a second UE.

14. The method as recited in claim 5, wherein the policy of the SP comprises a required assurance level of the multi-factor authentication, and wherein the first and second authentication agents are identified based on the assurance level of the multi-factor authentication.

15. The method as recited in claim 5, the method further comprising:
determining an aggregate assurance level based on an assurance level of the first ticket and an assurance level of the second ticket.

16. The method as recited in claim 5, the method further comprising:
identifying a third factor authentication agent to perform a third factor authentication; and
triggering the third factor authentication that results in a third ticket.

17. The method as recited in claim 5, wherein the first and second authentication agents are associated with a first and a second identity provider, respectively.

18. A user equipment (UE) in a communication network, the UE comprising:
a memory comprising executable; and
a processor that, when executing the executable instructions, effectuates operations comprising:
determining that multiple authentication factors are required to authenticate a user of the UE for access to a service provided by a service provider (SP);
identifying an authentication agent (AA) on a different device than the UE to perform an authentication utilizing one of the required authentication factors;
establishing a local link to the different device;
triggering the AA to perform the authentication; and
receiving, via the local link, an assertion representative of a successful authentication by the AA.

19. The UE as recited in claim 18, wherein the processor further effectuates operations comprising:
identifying one or more additional authentication agents on the UE to perform authentication utilizing at least one other of the required authentication factors.

20. The UE as recited in claim 18, wherein the processor further effectuates operations comprising:
identifying one or more additional authentication agents on a second different device from the UE to perform authentication utilizing at least one other of the required authentication factors.
